(19) United States
(12) Patent Application Publication
(10) Pub. No.: US 2024/0226874 A1
(43) Pub. Date: Jul. 11, 2024

(54) A KIT FOR ANALYSIS OF A MATERIAL SAMPLE FOR ONE OR MORE ANALYTES (VARIANTS)

(71) Applicant: ME & LABA S.L., Málaga (ES)

(72) Inventor: Olha Viacheslavivna LYTOVSKA, Monaco (MC)

(21) Appl. No.: 18/035,641

(22) PCT Filed: Mar. 20, 2023
(86) PCT No.: PCT/IB2023/052713

§ 371 Date: Sep. 28, 2023

(30) Foreign Application Priority Data
Mar. 22, 2022 (UA) U202200998

(51) Int. Cl. B01L 3/00

(52) U.S. Cl. CPC B01L 3/5023; B01L 2200/0689; B01L 2200/16; B01L 2300/0825; B01L 2300/0832

(57) ABSTRACT

The disclosure relates to the means for conducting a rapid analysis of biological samples using chromatographic analysis that can be applied in medicine, veterinary medicine, and food quality control. Provided a kit for analysis of a material sample for one or more analytes comprising a test device for receiving the material sample and for displaying the result of the analysis of the material sample, and a container for storing a buffer fluid required for the analysis of the material sample. The disclosure enables rapid and easy detection of the multiple analytes in the material sample, and prevention of irritation or trauma of the mucous membranes when collecting the material.

### FIELD OF INVENTION

The disclosure relates to the means for conducting a rapid analysis of biological samples using chromatographic analysis, in particular thin-layer chromatography, that can be applied in medicine, veterinary medicine, and food quality control.

### BACKGROUND OF INVENTION

Chromatography is a physico-chemical method for the analysis of the substances based on the distribution of the substance components between two phases—mobile and stationary ones. The stationary phase is usually a solid (sorbent), while the mobile phase is a liquid or gas that flows through the stationary phase. When the mobile phase is flowing through the stationary phase, the substance components separate and move along the stationary phase at different rates.

According to the technique of the separation of the substance components, there is a type of chromatography, in which the separation is performed in a thin layer of the sorbent. This method is called thin-layer chromatography (TLC).

In TLC method, a stationary solid phase (sorbent) is applied in a thin layer on a base, such as a plate or a strip (in the literature it is often referred to a “test plate” or a “test strip”). Various solvents, both organic and inorganic, or mixtures thereof are used as a mobile phase. The type of the solvent depends on the nature of the sorbent and the properties of the compounds or substances to be analyzed. Aqueous buffer solutions that create a constant pH value are often used as the solvents, which is why, in the literature sources, solvents used in TLC are often referred to as a “buffer fluid”. Although such a solvent may not actually be a buffer solution, that creates a constant pH value, it may still be referred to as the “buffer fluid”. TLC uses capillary forces that occur when the so-called starting edge of the plate or the strip is immersed into the solvent containing the substance to be analyzed. Due to capillary forces, the solvent containing the substance to be analyzed moves from the starting edge of the plate or the strip into the volume of the sorbent on the plate or the strip and transports the substance components at different rates. That leads to spatial separation and positioning of the substance components in different areas of the plate or the strip, and the formation of zones, such as spots or lines.

Target chemicals or substances, that need to be determined in the sample, are referred to as “analytes”. TLC conditions (such as sorbent, solvent) for detection of the analytes are selected in such a way that the spots or the lines formed on the plate or the strip acquire a characteristic color and become visible on the plate or the strip. In TLC implementation, the plate or the strip may be positioned inside a closed transparent chamber so that the solvent does not evaporate from the surface of the plate or the strip during TLC, and the solvent evaporation does not affect the TLC results.

The TLC method provides many advantages for the analysis, such as
(1) simplicity of the analysis;
(2) no demand for expensive equipment;
(3) rapidity, i.e. a short period of time (about 5-15 minutes) required to obtain the analysis results;
(4) no demand for significant quantities of the sample substance.

Advantages of TLC method, such as versatility, simplicity of the analysis, rapidity, and sensitivity, led to the widespread use of TLC for analytical purposes in biochemistry and medicine, e.g. for identification of the components of the drugs and biochemicals, as well as inorganic compounds and organic compounds of different classes.

One of the subtypes of TLC is immunochromatographic analysis. Immunochromatographic analysis (in the literature it is abbreviated as ICA, is also referred to as “Lateral flow test”) also relates to immunochemical analysis. ICA is based on the principle of the thin-layer chromatography, and it uses the reaction between the antigen and the corresponding antibody. The method is often performed using special test strips. In particular, ICA enables detection of antibodies to viruses and virus antigens in samples.

A known kit for collecting a material sample (such as saliva) and analyzing that sample for a single analyte (China utility model patent CN 216013389 U, publ. 11 Mar. 2022) comprises a test device for collecting the material sample and displaying the results of the analysis of the material sample, and a container for storing a buffer fluid required for the analysis of the material sample.

The test device comprises the following structural elements:
a housing configured in a shape of a tube made of transparent material, having a first end and a second end;
a locking tip connected to the first end of the housing;
an assembly for collecting the material sample connected to the second end of the housing;
a test strip holder for holding a single test strip fixed inside that is arranged inside the housing, wherein the test strip holder is configured in a cantilever shape;
a single test strip for analysis of the material sample for the analyte;
a sealing ring located on an outer portion of the second end of the housing.

The assembly for collecting the material sample comprises elements, such as a rod and an element for collecting the material sample. A first end of the rod is connected to the second end of the housing in such a way that a portion of the rod is arranged inside an orifice of the second end of the housing. A second end of the rod is configured in a cone shape. The element for collecting the material sample is configured in a cylindrical shape and is mounted on the rod.

The container comprises elements, such as a vessel containing a buffer fluid, a receiving tip for receiving the end of the test device with an attached assembly for collecting the material sample and for holding the test device in a certain position, and an impermeable membrane. The vessel containing the buffer fluid comprises a housing and a neck. The impermeable membrane is configured in a shape of a disk made of impermeable material and is mounted on the neck of the vessel containing the buffer fluid in such a way that it closes the orifice in the neck and prevents the buffer fluid from being spilt out during transportation and storage. The receiving tip is configured in a tube shape and is mounted on the housing of the vessel containing the buffer liquid. Configuration of the second end of the rod in a cone shape is caused by the need to pierce the impermeable membrane when the user introduces the test device into the container. Since the point of contact of the cone tip with the impermeable membrane has a small area, and the place of such contact concentrates all the force created by the user when introducing the test device into the container, it is, accordingly, apparent that a small force created by the user will be enough to pierce the material of the impermeable membrane.

The geometric sizes of the second end of the housing of the test device and the receiving tip of the container are adjusted in such a manner that when the second end of the test device with the attached assembly for receiving the material sample is introduced into the receiving tip of the container, the sealing ring located on the outer portion of the second end of the housing comes into close constant contact with the inner surface of the receiving tip, and the resulting friction force leads to holding the test device fixed in the container.

The kit is transported and delivered to the user in assembled mode, i.e. the test device is inserted into the container and held fixed in the container so that the second end of the rod of the assembly for collecting the material sample does not reach the impermeable membrane.

The known kit is used as follows.

The user removes the test device from the container, then introduces the test device into the mouth in such a manner that the element for collecting the material sample is positioned in the oral cavity; holds the element for collecting the material sample in the oral cavity for one to two minutes to allow the element for collecting the material sample to absorb a large amount of saliva; then removes the element for collecting the material sample from the oral cavity. Then, the user introduces the test device into the container so that the second end of the rod of the assembly for collecting the material sample reaches the impermeable membrane and pierces the impermeable membrane; upon that the element for collecting the material sample enters the buffer fluid. Since the sealing ring fits snugly both to the outer surface of the second end of the housing of the test device and to the inner surface of the receiving tip of the container, and prevents the buffer fluid from being spilled out of the container, the buffer fluid passes through the element for collecting the material sample, and, while moving, captures saliva located in the element for collecting the material sample. After that, the buffer fluid passes through the orifice of the second end of the housing of the test device, reaches the filter, and then passes to the end of the test strip that leans against the filter. The buffer fluid elutes the analyte, if present in the saliva, along the test strip. As a result, lines that show the presence or absence of the analyte in the saliva sample occur. The lines also show that the analysis of the saliva sample was correct, and the analysis result can be credible.

The disadvantages of the known kit are as follows:
the capability to determine the presence or absence of a single analyte in the material sample, as the test strip holder is configured to hold a single test strip; in the case of a complex analysis for multiple analytes in the material sample, there is a need to purchase and use multiple such kits;
an open cone in the second end of the rod can cause irritation or damage of the mucous membranes (for example, in the nose) in the case of collecting the material from the places of the body, other than the mouth.

### SUMMARY OF INVENTION

The first objective technical problem of this disclosure is to develop an improved kit for analysis of a material sample for one or more analytes, which, due to a change in design, allows determining the presence of multiple analytes in the material sample.

The second objective technical problem of this disclosure is to develop an improved kit for the analysis of a material sample for one or more analytes, which, due to a change in design, allows collection of the material without causing irritation or damage to various body tissues, for example, mucous membranes.

Another objective technical problem of this disclosure is to expand the variety and range of means for analysis of the material samples.

The first objective technical problem is solved with a kit for analysis of a material sample for one or more analytes, the kit comprising: a test device (1) for receiving the material sample and for displaying the result of the analysis of the material sample, and a container (2) for storing a buffer fluid required for the analysis of the material sample; the test device (1) comprises a housing (3) configured in a shape of a tube made of the transparent material, wherein the housing (3) comprises a first end (8) of the housing and a second end (9) of the housing, a locking tip (4) connected to the first end (8) of the housing, an assembly for receiving the material sample (5) connected to the second end (9) of the housing, at least one test strip (6) for analysis of the material sample for the analyte and for display of the result of the analysis; a test strip holder (7) for holding at least one test strip (6) fixed inside that is located inside the housing (3); the assembly for receiving the material sample (5) comprises a rod (10) and an element for receiving the material sample (11), wherein the first end (12) of the rod is connected to the second end (9) of the housing in such a way that a portion of the rod (10) is arranged inside the orifice of the second end (9) of the housing; the element for receiving the material sample (11) is mounted on the rod (10), wherein the test strip holder (7) is configured
either in a preferably cylindrical shape, wherein the surface of the test strip holder (7) comprises at least one recess for holding the test strip (6) fixed,
or in a preferably prism shape with a lateral surface formed by at least three lateral faces (23), each of which is a rectangle or parallelogram, and the surface of the lateral faces (23) comprises at least one recess for holding the test strips (6) fixed,
or to comprise a central longitudinal element (26), at least three longitudinal protrusions (28) and at least one radial ring element (29), wherein a central longitudinal element (26) is configured in a preferably prism shape with lateral edges and a lateral surface formed by at least three lateral faces (27), each of which is a rectangle or a parallelogram, wherein the longitudinal protrusions (28) are configured in such a way that each of them in cross-section has a shape of a truncated sector of a circle, and each longitudinal protrusion (28) is connected to the lateral edge of the central longitudinal element (26), wherein the radial ring element (29) is connected to the longitudinal protrusions (28) and is configured in such a way that slots (30) are formed between an inner surface (31) of the radial ring element (29) and the surface of the lateral faces (27).

According to one of the embodiments of the first disclosure, the test device (1) can comprise one, two, three, four, five or six test strips (6).

According to one of the embodiments of the first disclosure, the test strip holder (7) can be connected to the locking tip (4).

According to one of the embodiments of the first disclosure, the test strip holder (7) can be connected to the housing (3).

According to one of the embodiments of the first disclosure, the housing (3) can be configured in a shape of the tube in such a way that it has a preferably cylindrical shape.

According to one of the embodiments of the first disclosure, the housing (3) can be configured in a shape of the tube in such a way that it preferably has the lateral surface formed by at least three lateral faces (22), each of which is a rectangle or parallelogram.

According to one of the embodiments of the first disclosure, the lateral surface of the housing (3) can be formed by three, four, five or six lateral faces (22).

According to one of the embodiments of the first disclosure, the test strip holder (7) can be configured in a preferably prism shape with three, four, five or six lateral faces (23).

According to one of the embodiments of the first disclosure, at least one recess for holding the test strip (6) fixed can be arranged on one, two, three, four, five or six lateral faces (23).

According to one of the embodiments of the first disclosure, the test strip holder (7) can comprise the central longitudinal element (26), three longitudinal protrusions (28) and one radial ring element (29), wherein the central longitudinal element (26) is configured in a preferably prism shape with three lateral edges and the lateral surface formed by at least three lateral faces (27), wherein the radial ring element (29) is configured to form three slots (30).

According to one of the embodiments of the first disclosure, the test strip holder (7) can comprise the central longitudinal element (26), four longitudinal protrusions (28) and one radial ring element (29), wherein the central longitudinal element (26) is configured in a preferably prism shape with four lateral edges and the lateral surface formed by four lateral faces (27), wherein the radial ring element (29) is configured to form four slots (30).

According to one of the embodiments of the first disclosure, the test strip holder (7) can be configured in a preferably cylindrical shape, and further can comprise at least one radial ring element (35), wherein at least one recess on the surface of the test strip holder (7) is configured in such a way that at least one longitudinal plane (36) is formed on the surface of the test strip holder (7), wherein the radial ring element (35) is configured in such a way that slots (37) are formed between the inner surface of the radial ring element (38) and the surface of the longitudinal planes (36).

According to one of the embodiments of the first disclosure, the test device (1) further can comprise a sealing ring (14) arranged on an outer portion of the second end (9) of the housing, and further can comprise a protective cap (15) mounted on the second end (9) of the housing in such a way that the protective cap is in contact with the sealing ring (14) and prevents the element for receiving the material sample (11) from contact with other objects.

According to one of the embodiments of the first disclosure, the element for receiving the material sample (11) can be made of porous material or fibrous material.

According to one of the embodiments of the first disclosure, the element for receiving the material sample (11) can be configured in a cylindrical shape with an axial channel.

According to one of the embodiments of the first disclosure, the element for receiving the material sample (11) can be configured in a shape of the hollow cylinder comprising a first end (33) of the hollow cylinder and a second end (34) of the hollow cylinder, wherein the first end (33) of the hollow cylinder is configured to be open, the second end (34) of the hollow cylinder is configured to be closed.

According to one of the embodiments of the first disclosure, the first end (12) of the rod can be configured in a hook-like shape in such a way that it comprises a stop element (25) that can be bent back when being pressed and prevents the first end (12) of the rod from getting out from the second end (9) of the housing, when a portion (10) of the rod is inside the orifice in the second end (9) of the housing.

According to one of the embodiments of the first disclosure, the container (2) can comprise a vessel containing the buffer fluid (16), a receiving tip (17) for receiving the end of the test device (1) with the attached assembly for receiving the material sample (5) and for holding the test device (1) in a certain position, and an impermeable membrane (18); the vessel containing the buffer fluid (16) has a housing (19) of the vessel containing the buffer fluid and a neck (20) of the vessel containing the buffer fluid; the impermeable membrane (18) is configured in a shape of the disk made of impermeable material and mounted on the neck (20) in such a way that the impermeable membrane closes the orifice in the neck (20) and prevents the buffer fluid from being spilled out during transportation and storage; the receiving tip (17) is configured in a shape of the tube to be mounted on the housing (19) of the vessel containing the buffer fluid or on the outer portion of the neck (20) of the vessel containing the buffer fluid.

According to one of the embodiments of the first disclosure, the outer portion of the second end (9) of the housing can comprise a sealing collar (21).

According to one of the embodiments of the first disclosure, the outer portion of the second end (9) of the housing can comprise two retaining collars (24) for holding the sealing ring (14) arranged on the outer portion of the second end (9) of the housing.

According to one of the embodiments of the first disclosure, the analyte or analytes preferably can be selected from the group of substances consisting of antigens, antibodies, hormones, antibiotics, addictive substances, vitamins, disease markers, markers of allergic reactions, food quality markers, and the like.

According to one of the embodiments of the first disclosure, the antigens and antibodies can be antigens of viruses and antibodies to viruses, such as influenza viruses, coronaviruses, adenoviruses, human respiratory syncytial virus, HIV, hepatitis viruses, Epstein-Barr virus, Zika virus, dengue fever viruses, chikungunya fever virus, rubella virus, human cytomegalovirus, herpes viruses, and the like.

According to one of the embodiments of the first disclosure, the hormones preferably can be selected from the group of substances consisting of chorionic gonadotropin, luteinizing hormone, follicle-stimulating hormone, protein-1 that binds insulin-like growth factor, thyroid-stimulating hormone, thyroxine, triiodothyronine, and the like.

According to one of the embodiments of the first disclosure, the addictive substances preferably can be selected from the group of substances consisting of cannabinoids, synthetic cannabinoids, morphine, ecstasy, barbiturates, benzodiazepines, cocaine, amphetamine, methamphetamine, mephedrone, tramadol, oxycodone, pregabalin, tricyclic antidepressants, zopiclone, and the like.

According to one of the embodiments of the first disclosure, the diseases preferably can be respiratory diseases, infectious diseases, sexually transmitted diseases, hormonal diseases, transmissible diseases, infections of the gastrointestinal tract, cardiovascular diseases, diseases of any organs, kidney diseases, liver diseases, and the like.

According to one of the embodiments of the first disclosure, the allergic reactions preferably can be reactions to such factors as drugs, food, milk protein, gluten, egg white, seafood, peanuts, animals, cat hair, dog hair, pollen, ragweed pollen, fungus, mold, and the like.

The second objective technical problem is solved with a kit for analysis of a material sample for one or more analytes, the kit comprising: a test device (1) for receiving the material sample and for displaying the result of the analysis of the material sample, and a container (2) for storing a buffer fluid required for the analysis of the material sample; the test device (1) comprises a housing (3) configured in a shape of a tube made of the transparent material, the housing (3) comprises a first end (8) of the housing and a second end (9) of the housing, a locking tip (4) connected to the first end (8) of the housing, an assembly for receiving the material sample (5) connected to the second end (9) of the housing, at least one test strip (6) for analysis of the material sample for the analyte and for display of the result of the analysis; a test strip holder (7) for holding at least one test strip (6) fixed inside that is located inside the housing (3); the assembly for receiving the material sample (5) comprises a rod (10) and an element for receiving the material sample (11), wherein the first end (12) of the rod is connected to the second end (9) of the housing in such a way that a portion of the rod (10) is arranged inside the orifice of the second end (9) of the housing; the element for receiving the material sample (11) is mounted on the rod (10), wherein the element for receiving the material sample (11) is configured in a shape of a hollow cylinder comprising a first end (33) of the hollow cylinder and a second end (34) of the hollow cylinder, wherein the first end (33) of the hollow cylinder is configured to be open, and the second end (34) of the hollow cylinder is configured to be closed.

According to one of the embodiments of the second disclosure, the test device (1) can comprise one, two, three, four, five or six test strips (6).

According to one of the embodiments of the second disclosure, the element for receiving the material sample (11) can be made of porous material or fibrous material.

According to one of the embodiments of the second disclosure, the test strip holder (7) can be connected to the locking tip (4).

According to one of the embodiments of the second disclosure, the test strip holder (7) can be connected to the housing (3).

According to one of the embodiments of the second disclosure, the housing (3) can be configured in a shape of the tube in such a way that it has a preferably cylindrical shape.

According to one of the embodiments of the second disclosure, the housing (3) can be configured in a shape of the tube in such a way that it has a preferably lateral surface formed by at least three lateral faces (22), each of which is a rectangle or parallelogram.

According to one of the embodiments of the second disclosure, the lateral surface of the housing (3) can be formed by three, four, five or six lateral faces (22).

According to one of the embodiments of the second disclosure, the test strip holder (7) can be configured in a preferably cylindrical shape, wherein the surface of the test strip holder (7) has at least one recess for holding the test strip (6) fixed.

According to one of the embodiments of the second disclosure, the test strip holder (7) can further comprise at least one radial ring element (35), wherein at least one recess on the surface of the test strip holder (7) is configured in such a way that at least one longitudinal plane (36) is formed on the surface of the test strip holder (7), wherein the radial ring element (35) is configured in such a way that slots (37) are formed between the inner surface of the radial ring element (38) and the surface of the longitudinal planes (36).

According to one of the embodiments of the second disclosure, the test strip holder (7) can be configured in a preferably prism shape with the lateral surface formed by at least three lateral faces (23), each of which is a rectangle or parallelogram, and the lateral faces (23) comprise at least one recess for holding the test strips (6) fixed.

According to one of the embodiments of the second disclosure, the test strip holder (7) can be configured in a preferably prism shape with three, four, five or six lateral faces (23).

According to one of the embodiments of the second disclosure, at least one recess for holding the test strip (6) fixed can be arranged on one, two, three, four, five or six lateral faces (23).

According to one of the embodiments of the second disclosure, the test strip holder (7) can comprise a central longitudinal element (26), at least three longitudinal protrusions (28) and at least one radial ring element (29), wherein the central longitudinal element (26) is configured in a preferably prism shape with the lateral edges and the lateral surface formed by at least three lateral faces (27), each of which is a rectangle or a parallelogram, wherein the longitudinal protrusions (28) are configured in such a way that each of them in cross-section has a shape of a truncated sector of a circle, and each longitudinal protrusion (28) is connected to the lateral edge of the central longitudinal element (26), wherein the radial ring element (29) is connected to the longitudinal protrusions (28) and is configured in such a way that slots (30) are formed between an inner surface (31) of the radial ring element (29) and the surface of the lateral faces (27).

According to one of the embodiments of the second disclosure, the test strip holder (7) can comprise the central longitudinal element (26), three longitudinal protrusions (28) and one radial ring element (29), wherein the central longitudinal element (26) is configured in a preferably prism shape with three lateral edges and the lateral surface formed by three lateral faces (27), wherein the radial ring element (29) is configured to form three slots (30).

According to one of the embodiments of the second disclosure, the test strip holder (7) can comprise the central longitudinal element (26), four longitudinal protrusions (28) and one radial ring element (29), wherein the central longitudinal element (26) is configured in the preferably prism shape with four lateral edges and the lateral surface formed by four lateral faces (27), wherein the radial ring element (29) is configured to form four slots (30).

According to one of the embodiments of the second disclosure, the test device (1) further can comprise a sealing ring (14) located on an outer portion of the second end (9) of the housing, and further can comprise a protective cap (15) mounted on the second end of the housing (9) in such a way that the protective cap is in contact with the sealing ring (14) and prevents the element for receiving the material sample (11) from contact with other objects.

According to one of the embodiments of the second disclosure, the first end (12) of the rod can be configured in a hook-like shape in such a way that it comprises a stop element (25) that can be bent back when being pressed and prevents the first end (12) of the rod from getting out from the second end (9) of the housing, when a portion of the rod (10) is inside the orifice in the second end (9) of the housing.

According to one of the embodiments of the second disclosure, the container (2) can comprise a vessel containing the buffer fluid (16), a receiving tip (17) for receiving the end of the test device (1) with the attached assembly for receiving the material sample (5) and for holding the test device (1) in a certain position, and an impermeable membrane (18); the vessel containing the buffer fluid (16) has a housing (19) of the vessel containing the buffer fluid and a neck (20) of the vessel containing the buffer fluid; the impermeable membrane (18) is configured in a shape of the disk made of impermeable material and mounted on the neck (20) in such a way that the impermeable membrane closes the orifice in the neck (20) and prevents the buffer fluid from being spilled out during transportation and storage; the receiving tip (17) is configured in a shape of the tube to be mounted on the housing (19) of the vessel containing the buffer fluid or on the outer portion of the neck (20) of the vessel containing the buffer fluid.

According to one of the embodiments of the second disclosure, the outer portion of the second end (9) of the housing can comprise a sealing collar (21).

According to one of the embodiments of the second disclosure, the outer portion of the second end (9) of the housing can comprise two retaining collars (24) for holding the sealing ring (14) arranged on the outer portion of the second end (9) of the housing.

According to one of the embodiments of the second disclosure, the analyte or analytes preferably can be selected from the group of substances consisting of antigens, antibodies, hormones, antibiotics, addictive substances, vitamins, disease markers, markers of allergic reactions, food quality markers, and the like.

According to one of the embodiments of the second disclosure, the antigens and antibodies can be antigens of viruses and antibodies to viruses, such as influenza viruses, coronaviruses, adenoviruses, human respiratory syncytial virus, HIV, hepatitis viruses, Epstein-Barr virus, Zika virus, dengue fever viruses, chikungunya fever virus, rubella virus, human cytomegalovirus, herpes viruses, and the like.

According to one of the embodiments of the first disclosure, the hormones preferably can be selected from the group of substances consisting of chorionic gonadotropin, luteinizing hormone, follicle-stimulating hormone, protein-1 that binds insulin-like growth factor, thyroid-stimulating hormone, thyroxine, triiodothyronine, and the like.

According to one of the embodiments of the first disclosure, the addictive substances preferably can be selected from the group of substances consisting of cannabinoids, synthetic cannabinoids, morphine, ecstasy, barbiturates, benzodiazepines, cocaine, amphetamine, methamphetamine, mephedrone, tramadol, oxycodone, pregabalin, tricyclic antidepressants, zopiclone, and the like.

According to one of the embodiments of the first disclosure, the diseases preferably can be respiratory diseases, infectious diseases, sexually transmitted diseases, hormonal diseases, transmissible diseases, infections of the gastrointestinal tract, cardiovascular diseases, diseases of any organs, kidney diseases, liver diseases, and the like.

According to one of the embodiments of the first disclosure, the allergic reactions preferably can be reactions to such factors as drugs, food, milk protein, gluten, egg white, seafood, peanuts, animals, cat hair, dog hair, pollen, ragweed pollen, fungus, mold, and the like.

As used herein the term “material sample”, unless stated otherwise, refers to both an unprocessed sample and processed sample of any material. A portion of the material collected from the material is a material sample. A portion of either an unprocessed sample or a processed sample of any material introduced into the test device (1) is a material sample.

Specific cases of the material sample or material samples can be:
a) a biological material sample, wherein the biological material sample includes both, but not limited to:
   any unprocessed sample that can be collected in any physical form from the objects including, but not limited to, the body of any creature, any organs and tissues of the body of any creature (in particular, as swabs, scrapings and washes from various organs and tissues of the body of any creature), any substances that both are present in the body of any creature and excreted by the body of any creature, any biological fluids in the body of any creature (e.g., blood, saliva, gastric juice, sperm, vaginal secretions, and the like), any metabolic products of the body of any creature (e.g., urine, feces, and the like), any secretions, any physiological and pathological secretions of the body of any creature (e.g., nasal mucus, sweat, earwax, transudate, exudate, etc.); and that can include, but not limited to, any component of the body of any creature (such as cells and tissues), as well as any substances presented in the body of any creature;
   any processed sample obtained, using any method, from the unprocessed sample described above that may include, but not limited to, any components of any organ of the body of any creature, any components of any substances that both are present in the body of any creature and excreted by the body of any creature, any components of any biological fluids of the body of any creature (e.g., blood plasma, blood serum, and the like), any components of any metabolic products of the body of any creature, any components of any secretions, any physiological and pathological secretions of the body of any creature;
b) a sample of the food product, which means both any unprocessed sample that can be collected in any physical form from any food product, and any processed sample obtained using any method from an unprocessed sample described above;
c) a sample of a chemical substance, which means both any unprocessed sample that can be collected in any physical form from any chemical substance, and any processed sample obtained in any method from the unprocessed sample described above.

The term “creature” means any object of the living world, in particular, such as a plant, animal, human, and fungus.

As used herein the term “analyte”, unless stated otherwise, refers to any chemical object, such as:
(1) any chemical compound, the presence or absence of molecules of which in the material sample can be detected using this disclosure;
(2) any substance, the presence or absence of components of which in the material sample can be detected using this disclosure.

As used herein the term “buffer fluid” means any solvent that is used or can be used in thin-layer chromatography.

### BRIEF DESCRIPTION OF DRAWINGS

To better understand the essence of the disclosure, the following examples of the claimed disclosure are shown below in connection with the drawings provided in the Drawings.

FIG. 1 represents a general view of the elements of the kit for analysis of a material sample for one or more analytes.

FIG. 2 represents a front view of the test device (1).

FIG. 3 represents a section A-A from FIG. 2.

FIG. 4 represents a front view of the test device (1).

FIG. 5 represents a section C-C from FIG. 4.

FIG. 6 represents a front view of the housing (3).

FIG. 7 represents a top view of the housing (3).

FIG. 8 represents a front view of the housing (3).

FIG. 9 represents a top view of the housing (3).

FIG. 10 represents a front view of the housing (3).

FIG. 11 represents a top view of the housing (3).

FIG. 12 represents a front view of the housing (3).

FIG. 13 represents a front view of the test strip holder (7).

FIG. 14 represents a top view of the test strip holder (7).

FIG. 15 represents a front view of the test strip holder (7).

FIG. 16 represents a top view of the test strip holder (7).

FIG. 17 represents a front view of the test strip holder (7).

FIG. 18 represents a top view of the test strip holder (7).

FIG. 19 represents a front view of the test strip holder (7).

FIG. 20 represents a top view of the test strip holder (7).

FIG. 21 represents a bottom view of the test strip holder (7).

FIG. 22 represents a section E-E from FIG. 19.

FIG. 23 represents a section F-F from FIG. 19.

FIG. 24 represents a section G-G from FIG. 19.

FIG. 25 represents a section B-B from FIG. 2.

FIG. 26 represents a section B-B from FIG. 2.

FIG. 27 represents a section B-B from FIG. 2.

FIG. 28 represents a section D-D from FIG. 4.

FIG. 29 represents a section D-D from FIG. 4.

FIG. 30 represents a section D-D from FIG. 4.

FIG. 31 represents a section D-D from FIG. 4.

FIG. 32 represents a section D-D from FIG. 4.

FIG. 33 represents a front view of the rod (10).

FIG. 34 represents a top view of the rod (10).

FIG. 35 represents a front view of the rod (10).

FIG. 36 represents a left side view of the rod (10).

FIG. 37 represents a front view of the element for receiving the material sample (11).

FIG. 38 represents a cross-sectional view of the element for receiving the material sample (11).

FIG. 39 represents a front view of the housing (3) with the sealing ring (14).

FIG. 40 represents a front view of the housing (3) with the sealing ring (15), the attached assembly for receiving the material sample (5) and the mounted protective cap (15).

FIG. 41 represents a section H-H from FIG. 40.

FIG. 42 represents a front view of the housing (3) with the sealing collar (21).

FIG. 43 represents a front view of the container (2).

FIG. 44 represents a section I-I from FIG. 43.

FIG. 45 represents a section of the container (2) with the test device (1) introduced inside the container (2).

FIG. 46 represents a front view of the test strip holder (7).

FIG. 47 represents a right side view of the test strip holder (7).

FIG. 48 represents a bottom view of the test strip holder (7).

FIG. 49 represents a section J-J from FIG. 46.

FIG. 50 represents a section K-K from FIG. 46.

FIG. 51 represents a section L-L from FIG. 46.

FIG. 52 represents a front view of the test strip holder (7).

FIG. 53 represents a top view of the test strip holder (7).

FIG. 54 represents a bottom view of the test strip holder (7).

FIG. 55 represents a section M-M from FIG. 52.

FIG. 56 represents a section N-N from FIG. 52.

FIG. 57 represents a section O-O from FIG. 52.

### DETAILED DESCRIPTION OF INVENTION

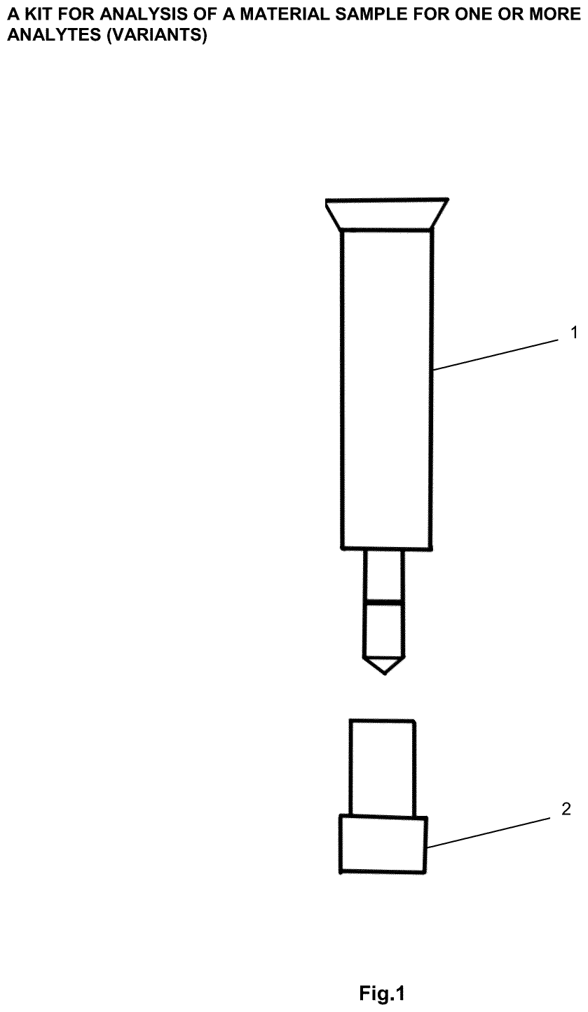

The kit for analysis of a material sample for one or more analytes comprises two separate elements, such as the test device (1) and the container (2) (see FIG. 1).

The test device (1) is configured to receive the material sample and display the results of the analysis of the material sample.

The container (2) is configured to store the buffer fluid required for the analysis of the material sample.

The test device (1) comprises elements, such as the housing (3), the locking tip (4), the assembly for receiving the material sample (5), the test strip (6), and the test strip holder (7).

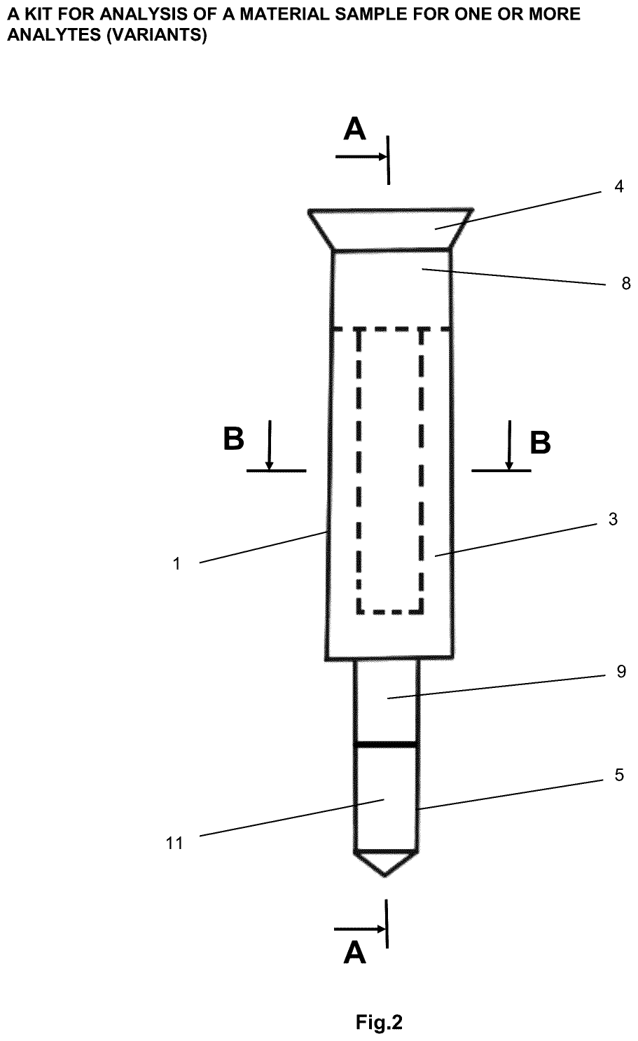

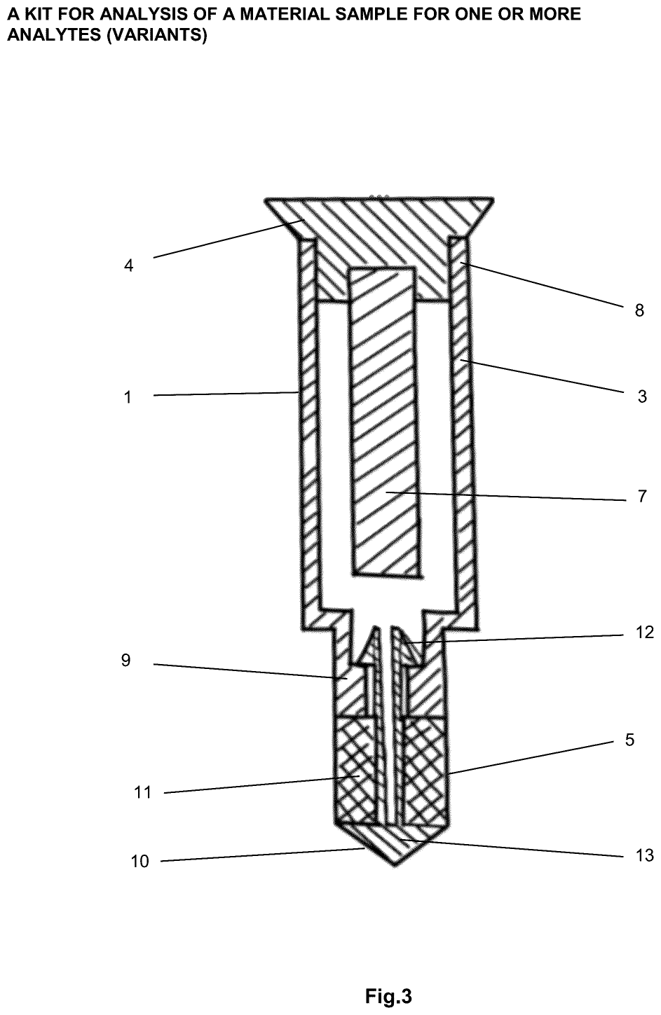

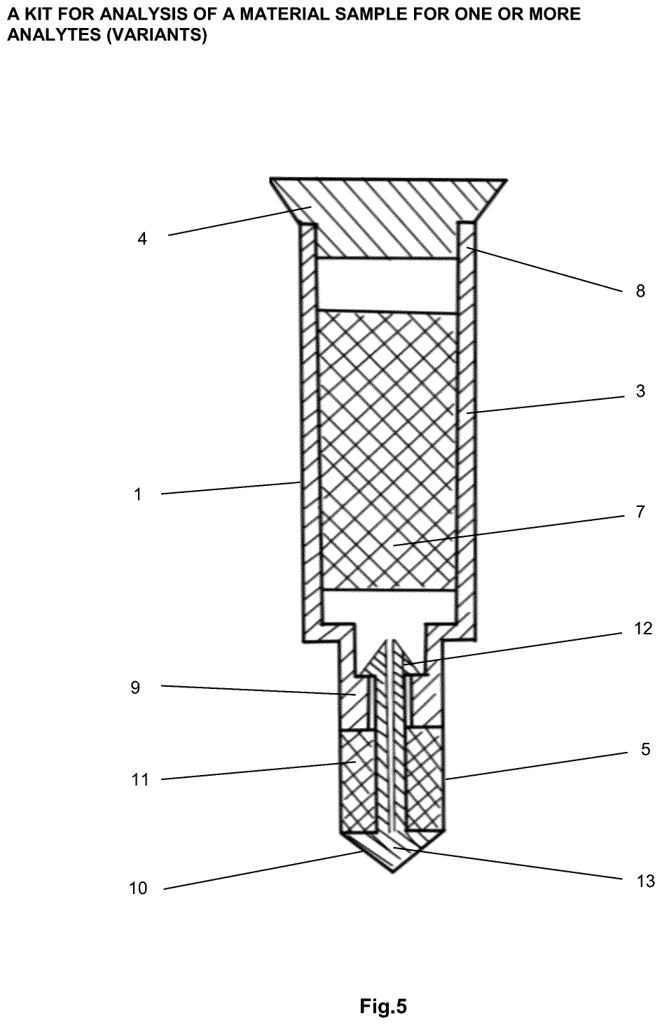

The housing (3) is configured in a shape of the tube made of the transparent material that has two ends, such as the first end (8) of the housing and the second end (9) of the housing (see FIGS. 2, 3, 4, and 5). There is the open orifice at each end of the housing (3). The locking tip (4) is connected to the first end (8) of the housing. There are two variants for the locking tip (4) to be connected to the first end (8) of the housing: according to the first variant, the locking tip (4) is introduced into the orifice in the first end (8) of the housing (shown in FIGS. 3 and 5); according to the second variant, the locking tip (4) is mounted on the outer surface of the first end (8) of the housing. The assembly for receiving the material sample (5) is connected to the second end (9) of the housing (shown in FIGS. 2, 3, 4, and 5).

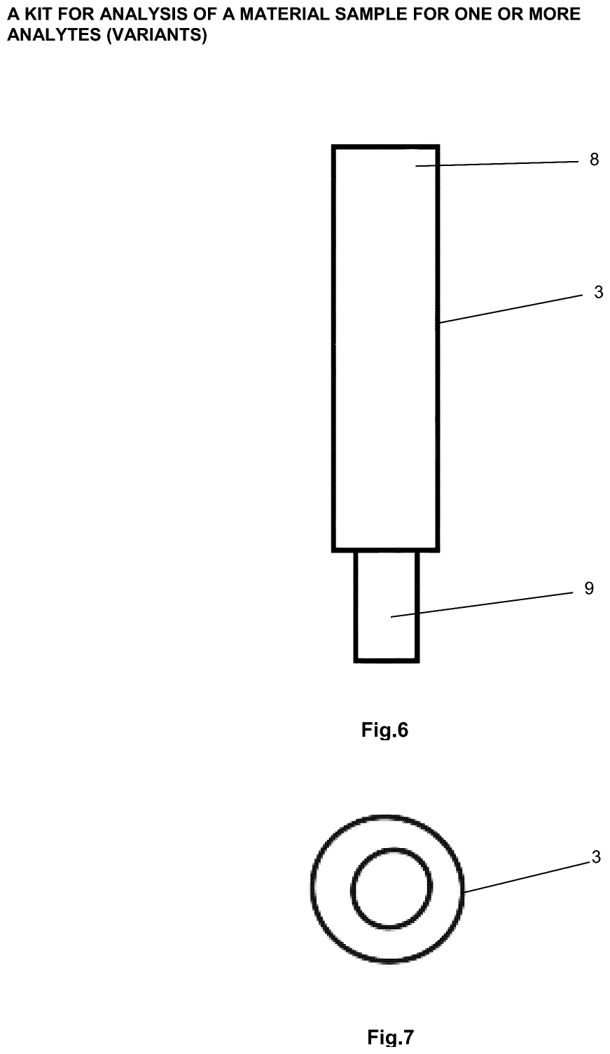

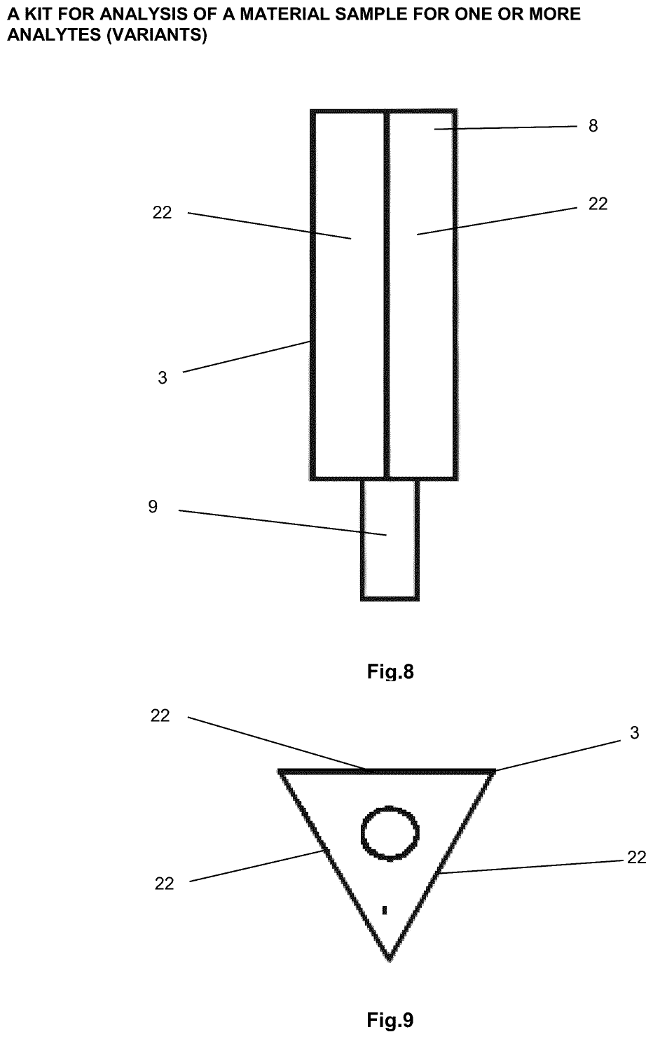

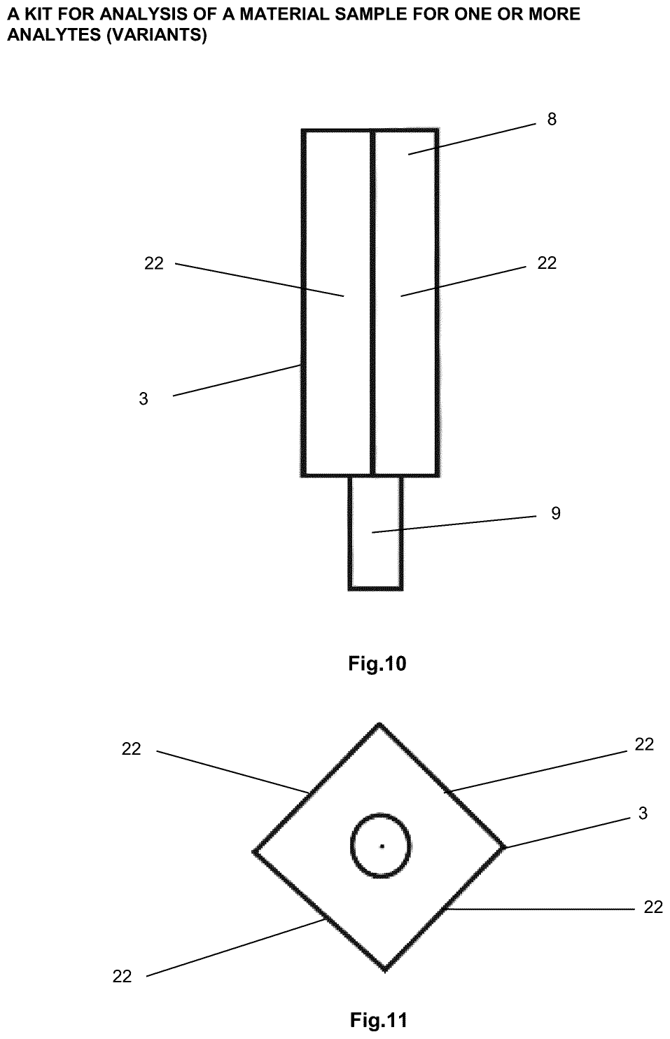

According to the claimed disclosure, the housing (3) can be configured in different shapes of the tube. According to one of the embodiments, the housing (3) can be configured in a shape of the tube of a preferably cylindrical shape (this embodiment of the housing (3) is shown in FIGS. 6 and 7 (front view and top view)). According to another embodiment, the housing (3) can be configured in a shape of the tube such that it preferably has the lateral surface formed by at least three lateral faces (22), each of which can be a rectangle or parallelogram. An embodiment of the housing (3) with three lateral faces (22) is represented in FIGS. 8 and 9 (front view and top view). An embodiment of the housing (3) with four lateral faces (22) is represented in FIGS. 10 and 11 (front view and top view). One skilled in the art will appreciate that the housing (3) can be configured in the shape of the tube such that it preferably has a lateral surface formed by more than four lateral faces (22), for example, five, six or seven lateral faces (22).

The test strip (6) is configured for analysis of the material sample for the analyte and display of the results of the analysis. The claimed disclosure may comprise at least one test strip (6). One or more test strips (6) are arranged on the element of the test device (1), such as the test strip holder (7) configured to hold at least one test strip (6) fixed.

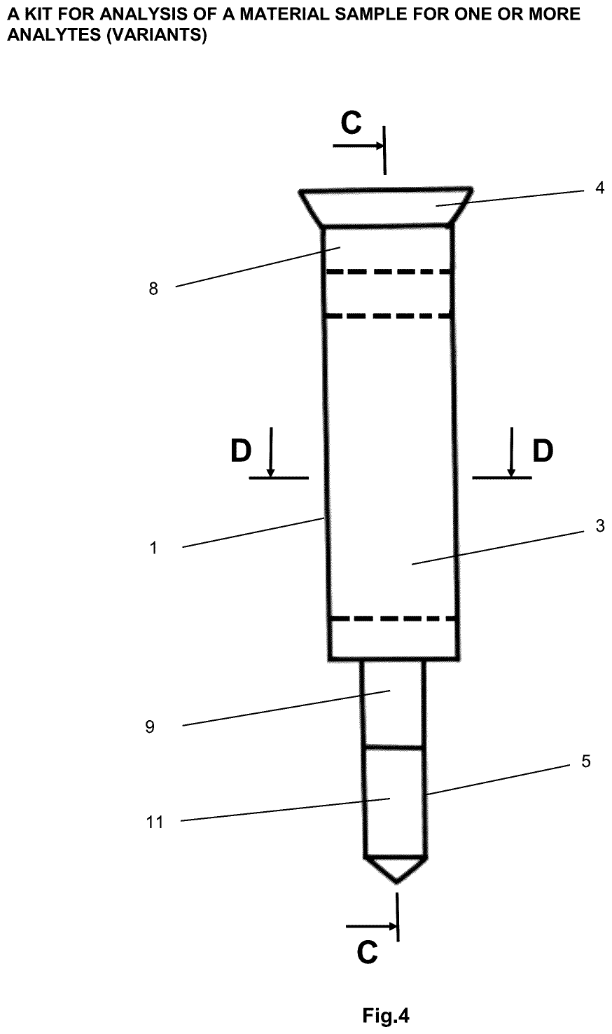

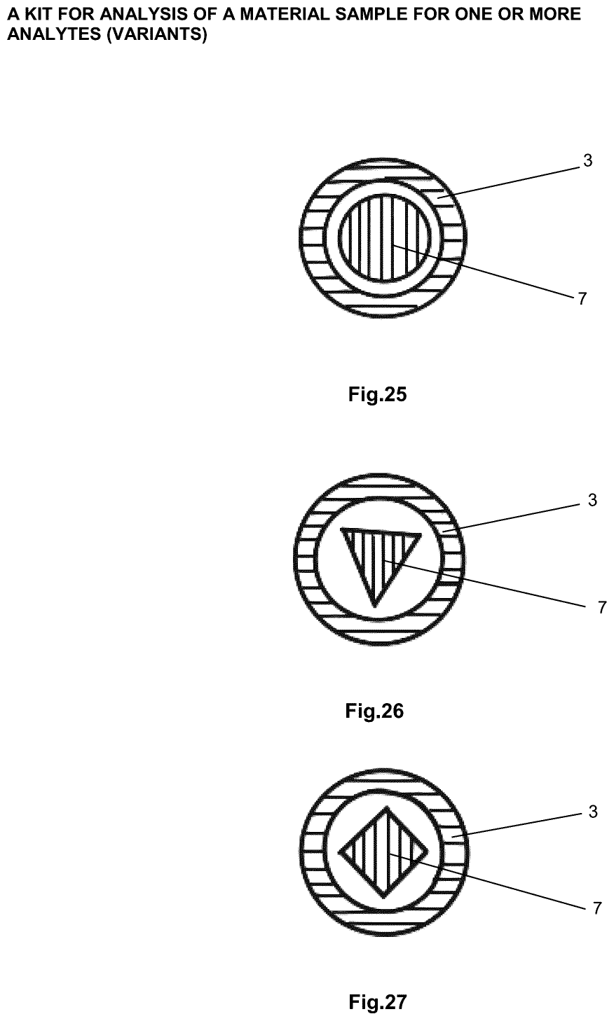

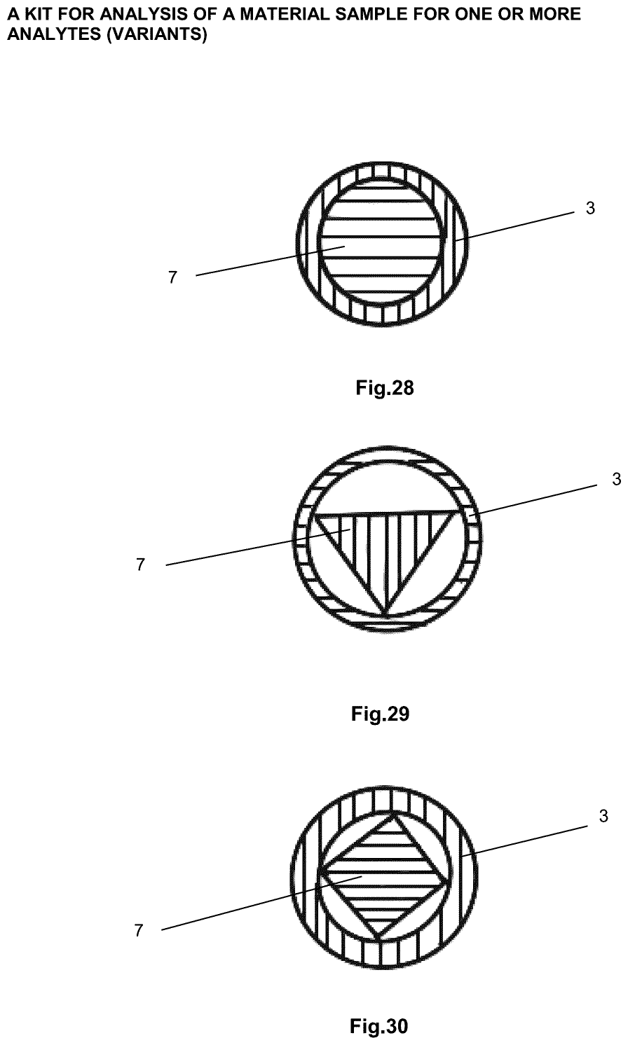

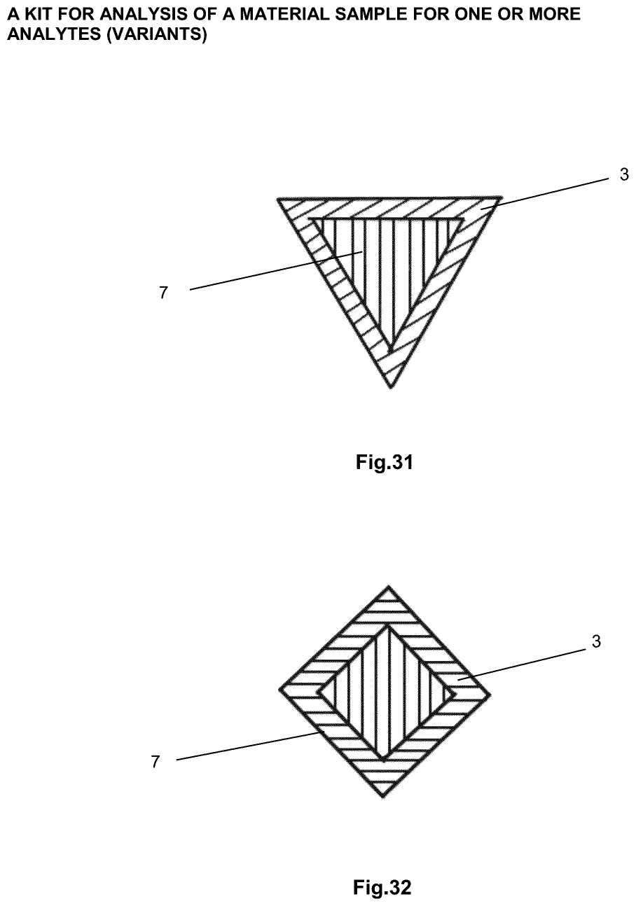

The test strip holder (7) is arranged inside the housing (3). Both when transporting the kit according to this disclosure and when testing the material sample for one or more analytes, the test strip holder (7) must be fixed relative to the housing (3). The following are possible variants of connection of the test strip holder (7) with other elements of the test device (1), which ensure its fixation. According to one of the embodiments, the test strip holder (7) can be connected to the locking tip (4), for example, the locking tip (4) comprises the recess of a certain shape, into which one end of the test strip holder (7) is to be introduced (this embodiment is shown in FIGS. 2 and 3 (dashed line shows the invisible boundaries of the lower portion of the locking tip (4) and invisible boundaries of the test strip holder (7), as well as in FIGS. 25, 26 and 27). According to another embodiment, the test strip holder (7) can be connected to the housing (3) by landing the test strip holder (7) inside the housing (3) with guaranteed negative allowance. This embodiment is shown in FIGS. 4 and 5 (dashed line shows the invisible boundaries of the lower portion of the locking tip (4) and invisible boundaries of the test strip holder (7)), as well as in FIGS. 28, 29, 30, 31, and 32.

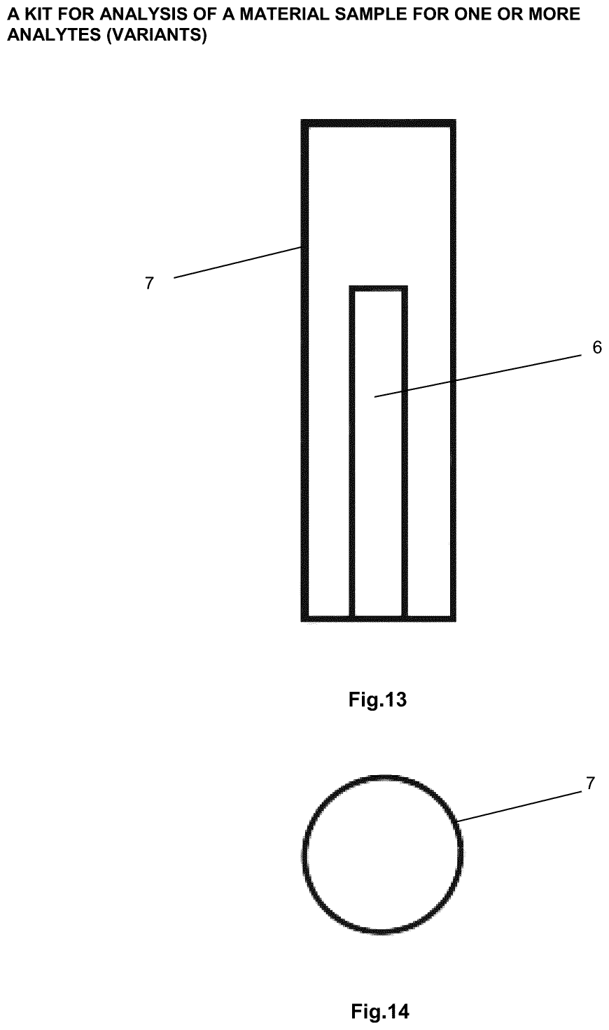

According to the claimed disclosure, the test strip holder (7) can be embodied in three different main embodiments, which in turn can have subembodiments. According to the first main embodiment of the test strip holder (7), the test strip holder (7) can be configured in a preferably cylindrical shape. This embodiment is represented in FIGS. 13 and 14 (front view and top view), 25 and 28 (a cross-sectional view of the housing (3) together with the test strip holder (7)).

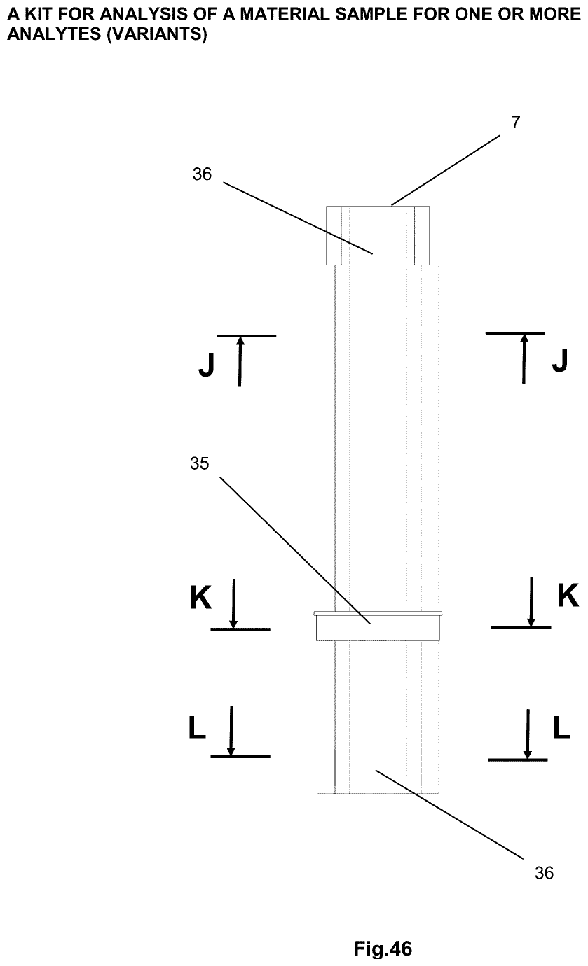

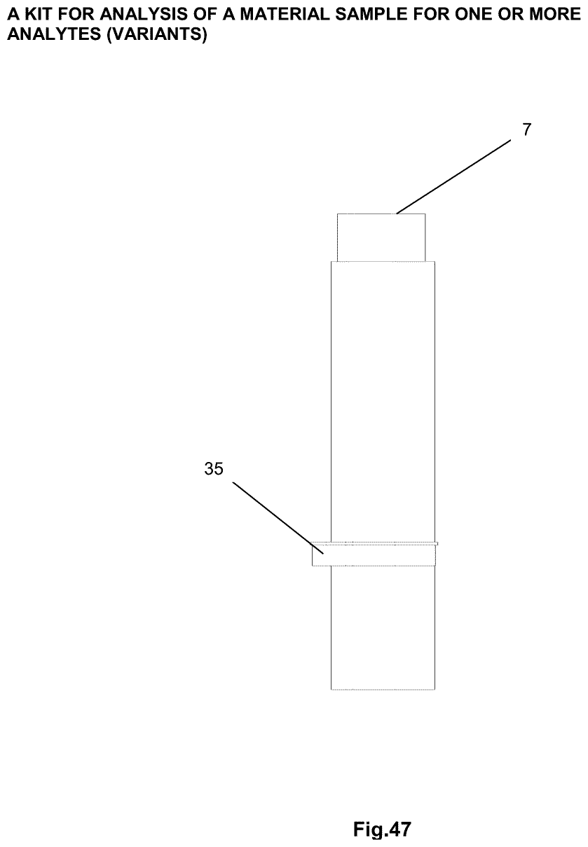

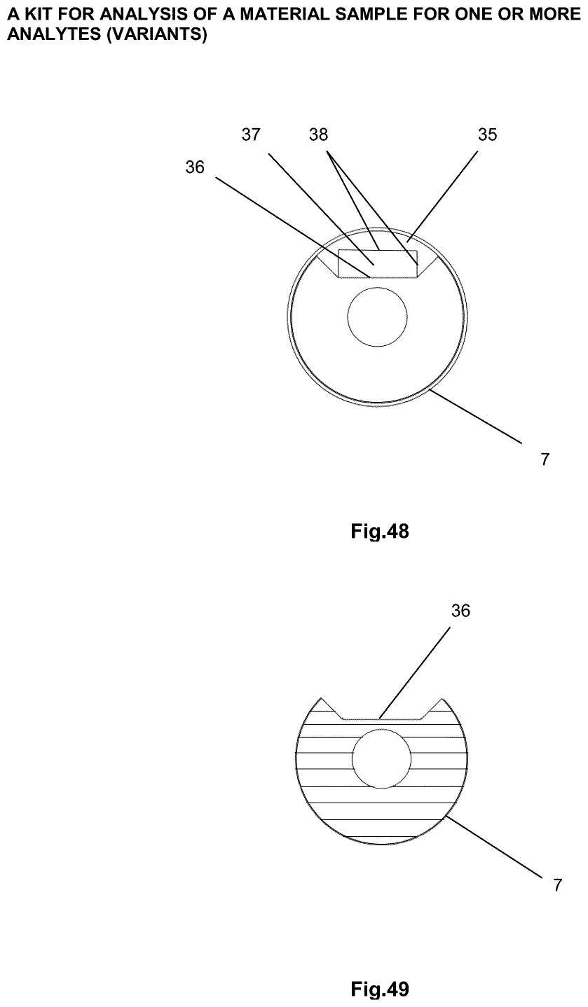

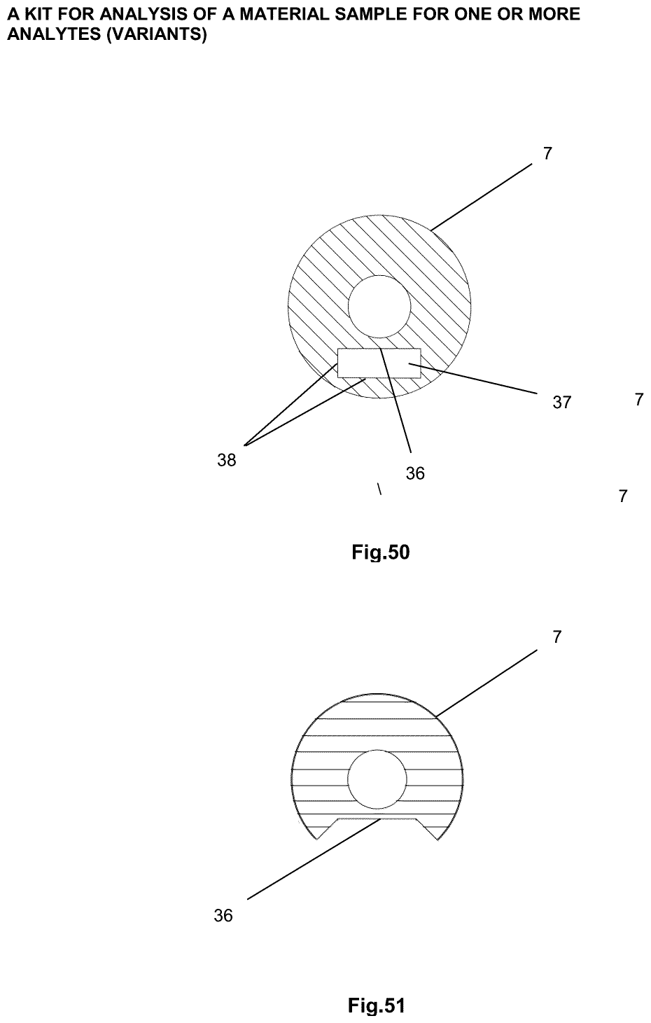

A subembodiment of the test strip holder (7) of the cylindrical shape may further comprise at least one element, such as the radial ring element (35) (see FIGS. 46, 47, 48, 49, 50, and 51). According to this subembodiment one or more recesses on the surface of the test strip holder (7) can be configured in such a way that at least one longitudinal plane (36) is formed on the surface of the test strip holder (7). The test strip holder (7) with one longitudinal plane (36) is represented in the Drawings, and it is apparent to one skilled in the art that number of such longitudinal planes (36) can be bigger. The radial ring element (35) is configured in such a way that slots (37) are formed between the inner surface (38) of the radial ring element (35) and the surface of the longitudinal planes (36) (see FIGS. 48 and 50). The slots (37) can be configured to enable the test strips (6) to pass through them, and can enable holding the test strips (6) in the test strip holder (7). The number of the slots (37) corresponds to the number of recesses in the test strip holder (7), and accordingly, corresponds to the number of longitudinal planes (36) on the surface of the test strip holder (7). FIGS. 48 and 50 represent the slots (37), each of which can have the quadrilateral shape and can be formed by three inner surfaces (38) of the radial ring element (35) and one surface of the longitudinal plane (36). It is apparent and obvious that the slots (37) can have a different shape.

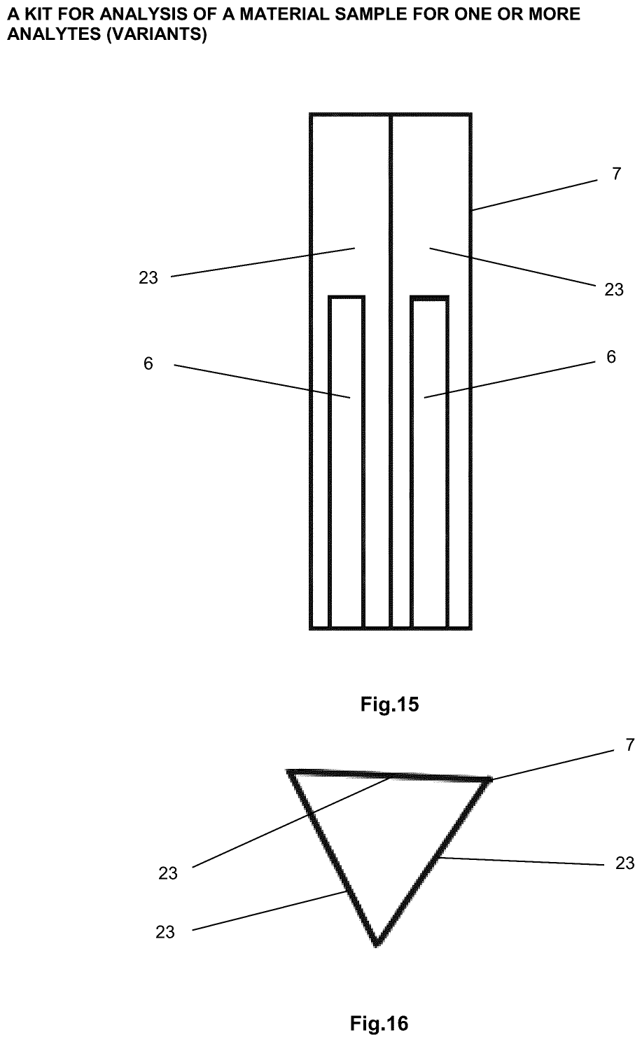

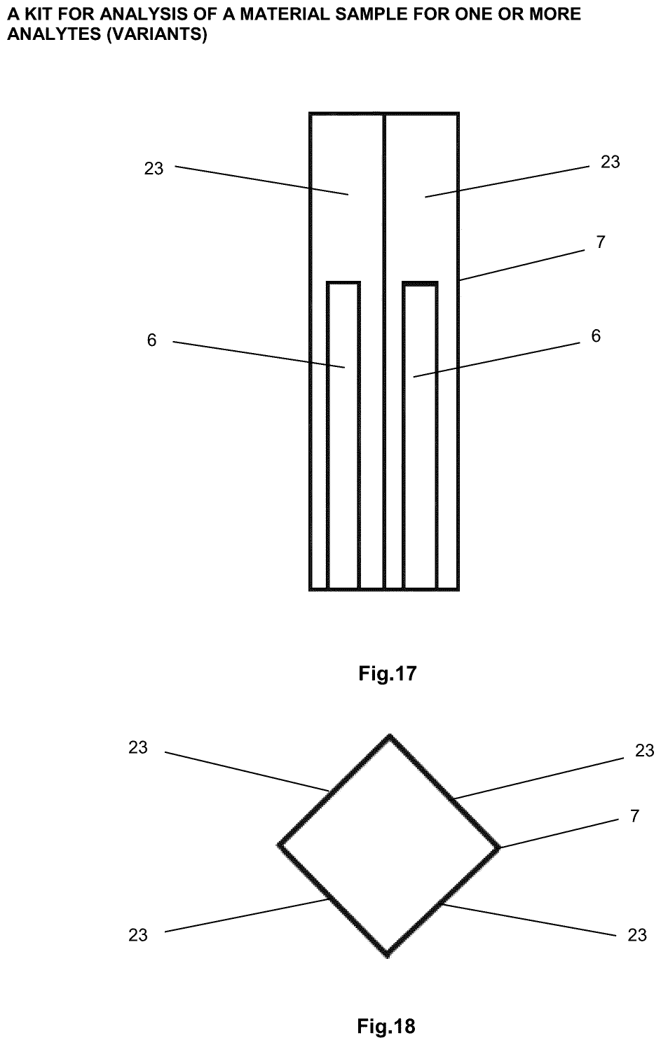

According to the second main embodiment of the test strip holder (7), the test strip holder (7) may be configured in a preferably prism shape with the lateral surface formed by at least three lateral faces (23), each of which can be a rectangle or parallelogram. An embodiment of the test strip holder (7) with three lateral faces (23) is represented in FIGS. 15 and 16 (front view and top view), 26, 29 and 31. An embodiment of the test strip holder (7) with four lateral faces (23) is represented in FIGS. 17 and 18 (front and top view), 27, 30 and 32. It will be apparent to one skilled in the art that the test strip holder (7) can be configured in a preferably prism shape with the lateral surface formed by more than four lateral faces (23), each of which can be a rectangle or parallelogram, for example, five, six or seven lateral faces (23).

According to the claimed disclosure, the surface of the test strip holder (7) according to the first and the second main embodiments can comprise at least one recess configured to hold at least one test strip (6) fixed. According to the subembodiment of the second main embodiment of the test strip holder (7), one or more recesses for holding the test strips (6) fixed can be positioned on one or more lateral faces (23) of the test strip holder (7). FIG. 13 represents an embodiment of the test strip holder (7) with one strip (6), and FIGS. 15 and 17 represent an embodiment of the test strip holder (7) with two strips (6). It is apparent to one skilled in the art that the test strip holder (7) in FIG. 15 can comprise three test strips (6), such as one strip per each lateral face (23); the test strip holder (7) in FIG. 17 can comprise both three test strips (6) and four test strips (6), such as one test strip (6) per each lateral face (23). For one skilled in the art it is also apparent that it is possible to configure the test strip holder (7) in such a way that more test strips (6) can be fixed in it, for example, five or six. The number of the test strips is limited only by the geometric sizes of the test strips (6), as well as by the shape and the geometric sizes of the test strip holder (7).

According to the third main embodiment of the test strip holder (7), the test strip holder (7) can comprise the central longitudinal element (26), at least three longitudinal protrusions (28) and at least one radial ring element (29).

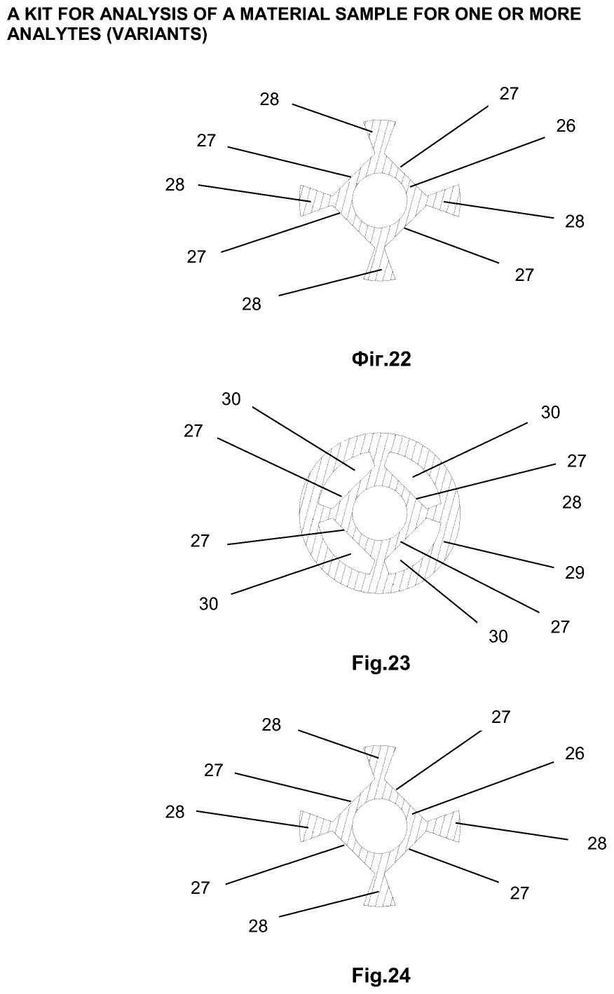

In a subembodiment of the third main embodiment of the test strip holder (7) that can comprise the central longitudinal element (26), four longitudinal protrusions (28) and one radial ring element (29), wherein the central longitudinal element (26) can be configured in a preferably prism shape with four lateral edges and the lateral surface formed by four lateral faces (27), the radial ring element (29) can be configured to form four slots (30) represented in FIGS. 19, 20, 21, 22, 23 and 24.

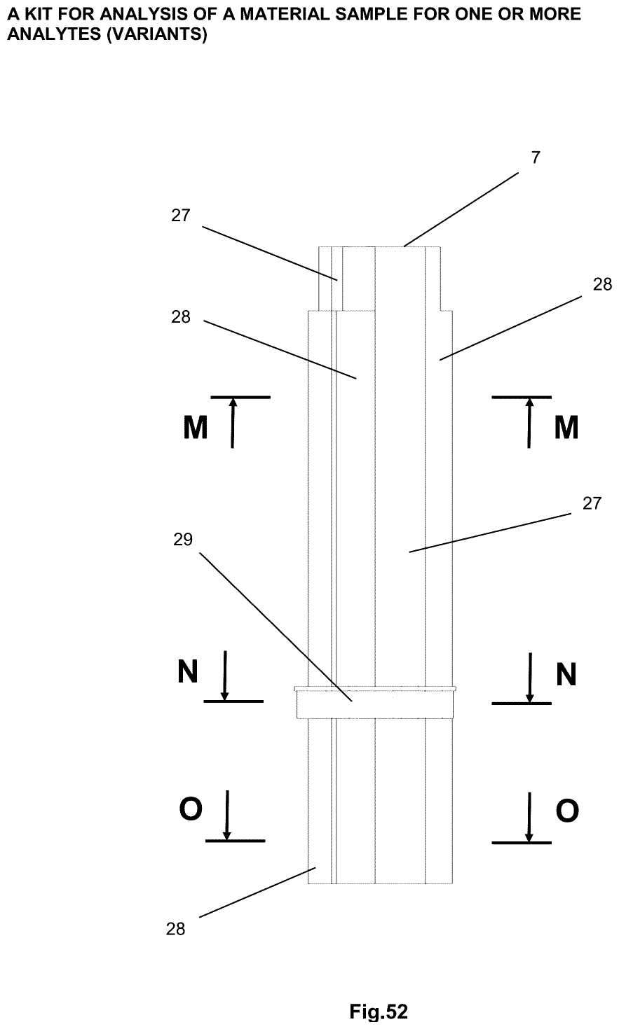

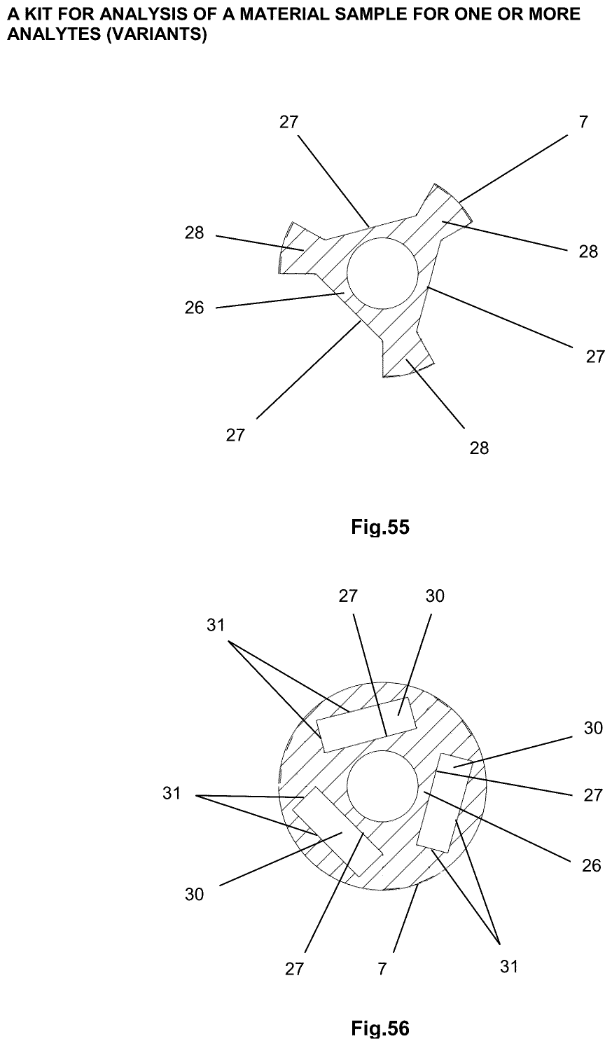

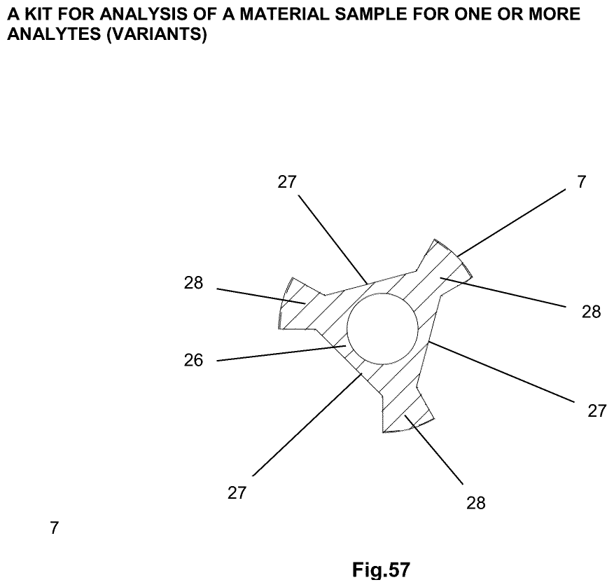

In a subembodiment of the third main embodiment of the test strip holder (7) that can comprise the central longitudinal element (26), three longitudinal protrusions (28) and one radial ring element (29), wherein the central longitudinal element (26) can be configured in a preferably prism shape with three lateral edges and the lateral surface formed by three lateral faces (27), the radial ring element (29) can be configured to form three slots (30) represented in FIGS. 52, 53, 54, 55, 56 and 57.

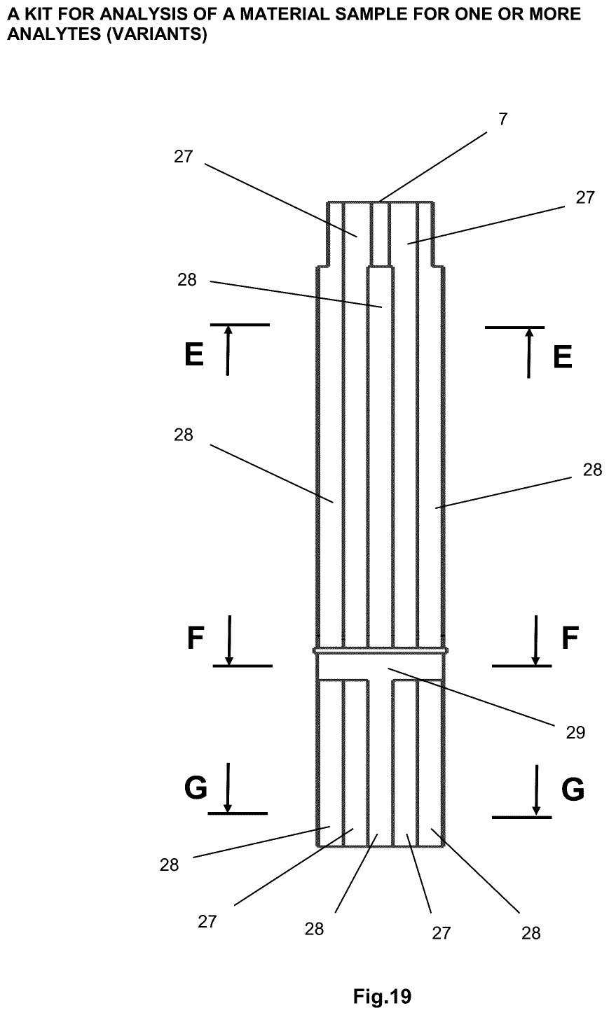

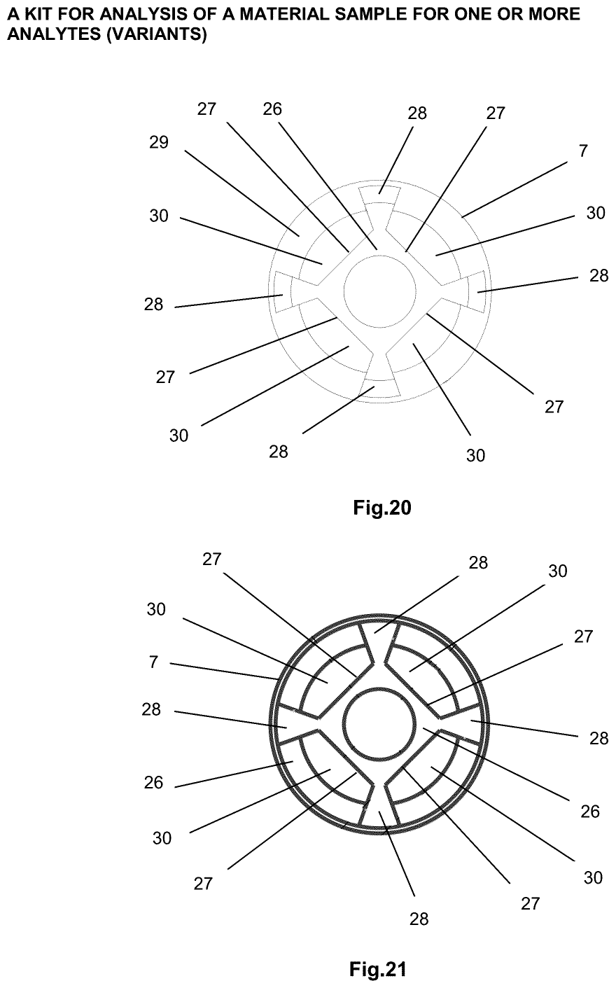

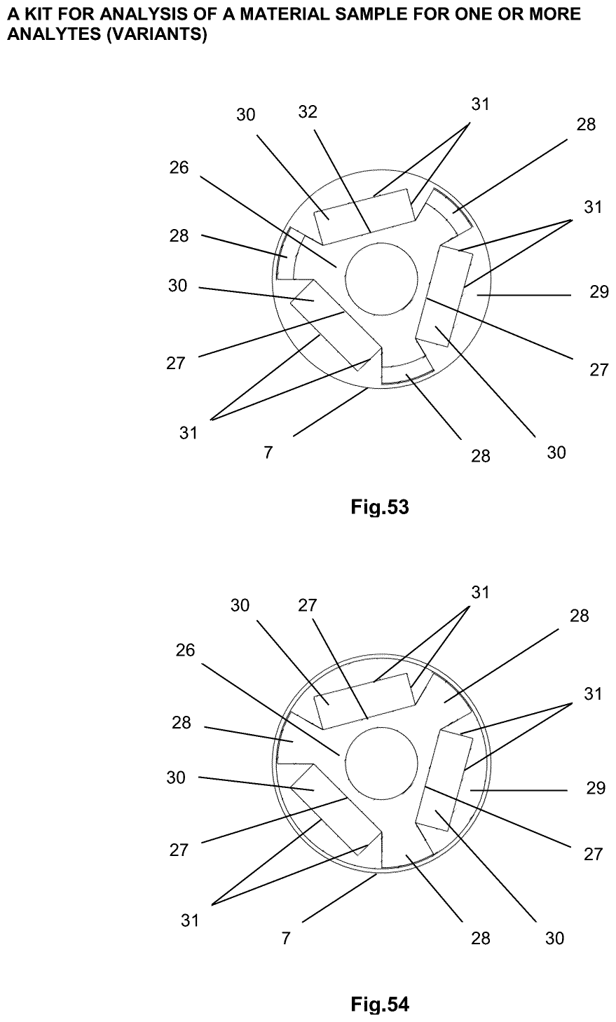

The central longitudinal element (26) can be configured in a preferably prism shape with the lateral edges and the lateral surface formed by at least three lateral faces (27). Each lateral face (27) can be a rectangle or a parallelogram. FIGS. 20 (top view), 21 (bottom view), 22, 23 and 24 (cross-sectional views of the test strip holder (7) at three different parts) show a central longitudinal member (26) with four lateral faces (27). FIGS. 53 (top view), 54 (bottom view), 55, 56 and 57 (cross-sectional views of the test strip holder (7) at three different parts) show the central longitudinal member (26) with three lateral faces (27). It will be apparent to one skilled in the art that the central longitudinal member (26) can be configured with a different number of the lateral faces (27), for example with five lateral faces (27), six lateral faces (27).

The longitudinal protrusions (28) are configured in such a way (see FIGS. 20, 21, 22, 24, 53, 54, 55, 57) that each of them in cross-section has a shape of a truncated sector of a circle. Each longitudinal protrusion (28) is connected to the lateral edge of the central longitudinal element (26), i.e. the number of the longitudinal protrusions (28) corresponds to the number of the lateral edges and the number of the lateral faces (27) in the central longitudinal element (26). In the case of the central longitudinal element (26) with three lateral faces (27), the test strip holder (7) can have three longitudinal protrusions (28), and in the case of the central longitudinal element (26) with four lateral faces (27), the test strip holder (7) can have four longitudinal protrusions (28) (as shown in the Drawings).

The radial ring element (29) can be connected to the longitudinal protrusions (28) and can be configured to form the slots (30) (see FIGS. 20, 21, 23, 53, 54, 56). FIGS. 19 and 52 show the test strip holder (7) with one radial ring element (29), but it will be apparent to one skilled in the art that the test strip holder (7) can be configured with two or three radial ring elements (29). Each of the slots (30) can be formed by the inner surface (31) of the radial ring element (29) and the surface of the lateral face (27). FIGS. 53, 54 and 56 show the slots (30), each of which can have a quadrilateral shape and can be formed by three inner surfaces (31) of the radial ring element (29) and one surface of the lateral face (27). It is apparent and obvious that the slots (37) can have a different shape. Slots (30) can be configured to enable the test strips (6) to pass through them. The radial ring element (29) can be configured to hold the test strip (6) in the test strip holder (7). Longitudinal protrusions (28) can be configured to visually “separate” each of the test strips (6) from the adjacent test strips.

Any test strip (6) that enables detection of the analyte in the sample by thin-layer chromatography can be used as the test strip according to this disclosure. The analyte or analytes that can be detected using this disclosure can be any target chemical compounds or substances that need to be identified in the material sample.

For example, the analyte or analytes may be selected from the group of substances consisting of antigens, antibodies, hormones, antibiotics, addictive substances, vitamins, disease markers, allergic reaction markers, food quality markers, and the like.

For example, antigens and antibodies that can be detected are antigens of the following viruses and antibodies to the following viruses: influenza viruses, coronaviruses, adenoviruses, human respiratory syncytial virus, HIV, hepatitis viruses, Epstein-Barr virus, norovirus, astroviruses, dengue fever viruses, chikungunya fever virus, rubella virus, human cytomegalovirus, herpes viruses, and the like.

For example, hormones that can be detected are substances selected from the group of substances consisting of chorionic gonadotropin, luteinizing hormone, follicle-stimulating hormone, protein-1 that binds insulin-like growth factor, thyroid-stimulating hormone, thyroxine, triiodothyronine, and the like.

For example, addictive substances that can be detected are substances selected from the group of substances consisting of cannabinoids, synthetic cannabinoids, morphine, ecstasy, barbiturates, benzodiazepines, cocaine, amphetamines, methamphetamine, mephedrone, tramadol, oxycodone, pregabalin, tricyclic antidepressants, zopiclone, and the like.

For example, diseases that can be detected by disease markers are respiratory diseases, infectious diseases, sexually transmitted diseases, hormonal diseases, transmissible diseases, gastrointestinal infections, cardiovascular diseases, diseases of any organs, kidney diseases, liver diseases, and the like.

In particular, diseases can include:
respiratory diseases (influenza, coronavirus, adenoviral diseases, diseases caused by human respiratory syncytial virus, pneumonia, streptococcal sore throat, tuberculosis);
common infectious diseases (HIV, type A, B, C, E hepatitis, syphilis, gonorrhea, chlamydia, TORCH infections (toxoplasmosis, rubella, cytomegalovirus and herpes), brucellosis, diseases caused by Epstein-Barr virus);
infections of the gastrointestinal tract (diseases caused by adenoviruses, rotaviruses, noroviruses, astroviruses, cryptococci, Giardia, Helicobacter pylori, campylobacteriosis, salmonellosis, cholera);
transmissible diseases (malaria, dengue fever, chikungunya fever, leishmaniasis, typhus, diseases caused by Zika virus);
diseases of kidneys and liver;
diseases of various organs;
cardiac diseases (detection of the analytes, such as troponin, myoglobin, creatine kinase, d-dimer);
oncological diseases (detection of the analytes, such as occult blood in feces, prostate-specific antigen, ferritin, transferrin, lactoferrin, alpha fetoprotein, carcinoembryogenic antigen);
fertility problems (detection of the analytes, such as chorionic gonadotropin, luteinizing hormone, follicle-stimulating hormone, protein-1, which binds insulin-like growth factor).

For example, allergic reactions that can be detected by markers are reactions to drugs, food, milk protein, gluten, egg white, seafood, cashews, peanuts, animals, cat hair, dog hair, pollen, ragweed pollen, fungus, mold, and the like.

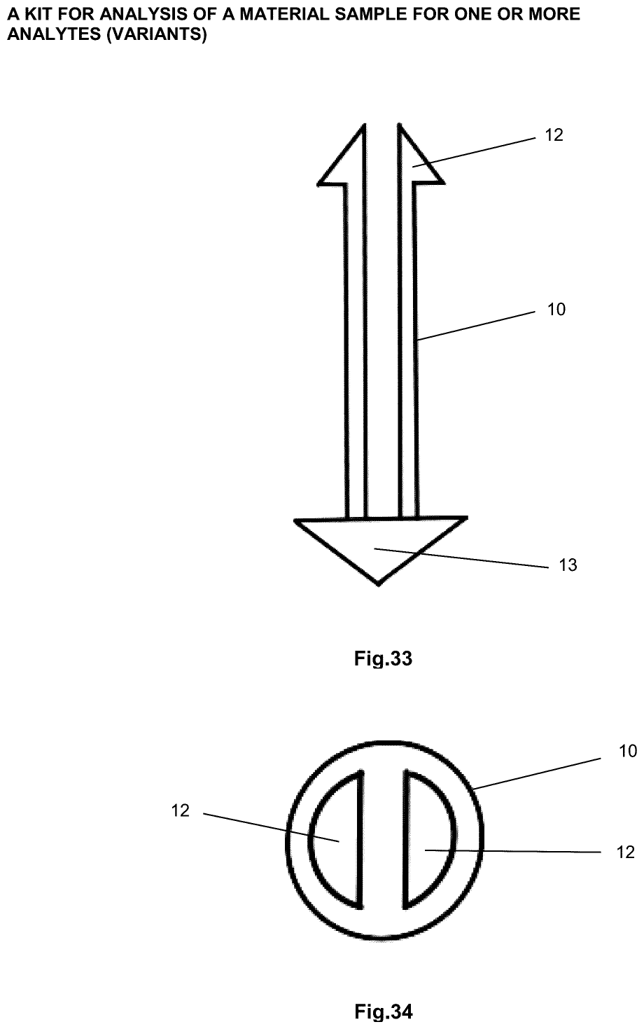

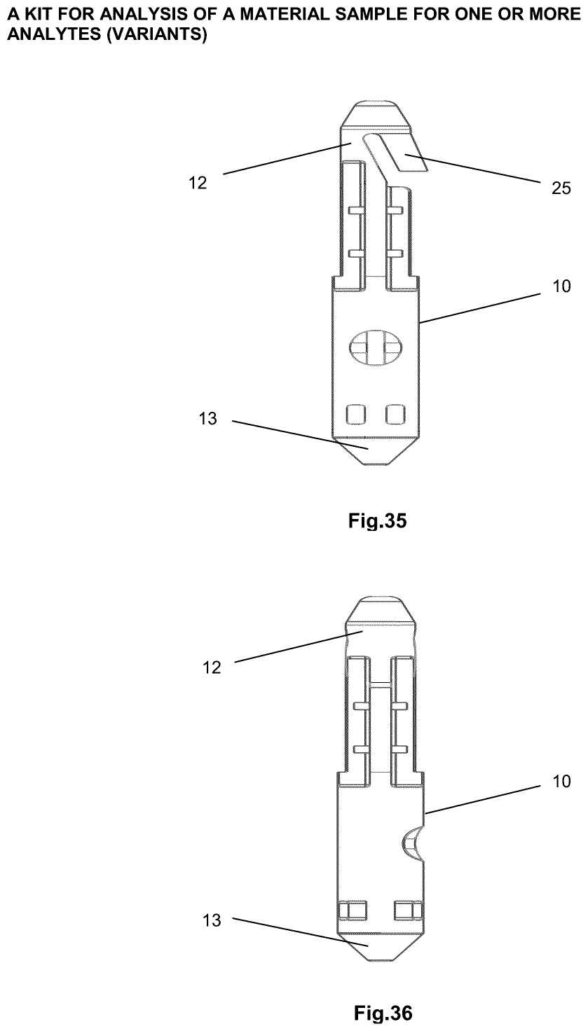

The assembly for receiving the material sample (5) can comprise the rod (10) and the element for receiving the material sample (11) (see FIGS. 3 and 5). The rod (10) can comprise the first end of the rod (12) and the second end of the rod (13). The rod (10) must be configured to enable the passage of the buffer fluid that passed through the element for receiving the material sample (11) further into the housing (3). One possible embodiment of the rod (10) is shown in FIGS. 33 (a front view) and 34 (a top view). Another embodiment of the structure of the rod (10) is provided in FIGS. 35 (a front view) and 36 (a side view). The first end (12) of the rod can be configured in a hook-like shape so that it can comprise the stop element (25) which can be bent back when being pressed and which can prevent the first end (12) of the rod from getting out of the second end (9) of the housing when the portion of the rod (10) is inside the orifice in the second end (9) of the housing. The first end (12) of the rod can be connected to the second end (9) of the housing so that a portion of the rod (10) is arranged inside the orifice of the second end (9) of the housing. The second end (13) of the rod can be configured in a cone shape.

The element for receiving the material sample (11) can be mounted on the rod (10). According to one embodiment, the element for receiving the material sample (11) is made of porous material or fibrous material. The porous material or fibrous material of the element for receiving the material sample (11) enables the element for receiving the material sample (11) to receive a significant volume of the material sample, which, accordingly, increases the accuracy of the analysis of the material sample for one or more analytes.

According to one of the embodiments, the element for receiving the material sample (11) can be configured in the cylindrical shape with an axial channel. This configuration of the element for receiving the material sample (11) enables the assembly for receiving the material sample (5) to be produced by folding with inserting the rod (10) into the axial channel in the element for receiving the material sample (11). In addition, it enables the production of the assembly for receiving the material sample (5) with different geometric sizes (diameter and length) of the element for receiving the material sample (11).

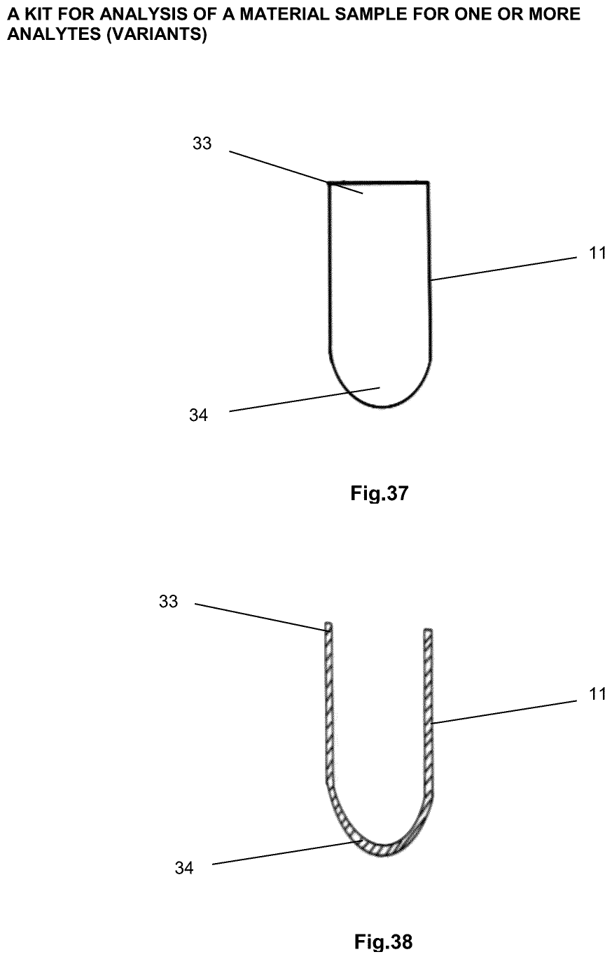

According to one of the embodiments, the element for receiving the material sample (11) can be configured in a shape of the hollow cylinder with the first end (33) of the hollow cylinder and the second end (34) of the hollow cylinder configured in such a way that the first end (33) of the hollow cylinder is open, the second end (34) of the hollow cylinder is closed (see FIGS. 37 and 38). This configuration of the element for receiving the material sample (11) enables covering the second end (13) of the rod configured in a cone shape, and is appropriate in the case of direct sampling of the material using the element for receiving the material sample (11) by introducing the rod (10) with the mounted element for receiving the material sample (11), for example, into particular body cavity, for enabling the contact with mucous membranes, for taking the swab, etc. This embodiment of the element for receiving the material sample (11) prevents accidental irritation and injury of the mucous membranes, etc.

Reception of the material sample by the element for receiving the material sample (11) can be performed in two embodiments. According to the first embodiment, reception of the material sample by the element for receiving the material sample (11) is performed in one step, such as by direct collection of the material sample using the element for receiving the material sample (11). In this embodiment, the material sample immediately lands on the element for receiving the sample material (11).

For example, when the assembly for receiving the material sample (5) comprises the element for receiving the material sample (11) with small diameter, the test device (1) according to this disclosure can be embodied for receiving the material sample by collecting the material, such as a nasal swab. Collection of the nasal swab from the nasal cavity can be performed by introducing the element for receiving the material sample (11) into the nasal cavity and sliding the surface of the element for receiving the material sample (11) along the nasal mucosa, for example, by rotating the test device (1) several times.

Another embodiment of the test device (1) according to this disclosure for receiving the material sample by collecting the material can include saliva collection, which is accomplished by introducing the element for receiving the material sample (11) into the mouth and holding it in the mouth for 1 to 2 minutes. Another possible variant for collection of the swab is a vaginal swab and/or an anal swab.

According to the second embodiment, reception of the material sample by the element for receiving the material sample (11) is performed in two steps. First, the material sample is collected, then particular volume of the material sample is applied on the element for receiving the material sample (11), or the element for receiving the material sample (11) is immersed in the material sample collected. With the second embodiment of reception of the material sample by the element for receiving the material sample (11), it is possible to analyze any unprocessed material samples, as well as any processed material samples to be further analyzed, such as, for example, blood, gastric juice, urine, feces, sweat, earwax, transudates, exudates, swabs, scrapes and washes from various organs and tissues of the body, as well as food.

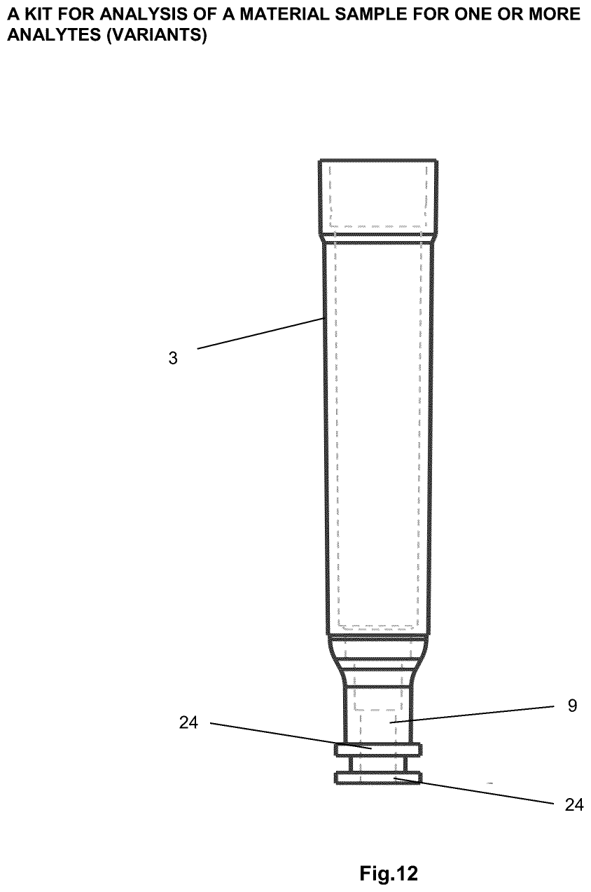

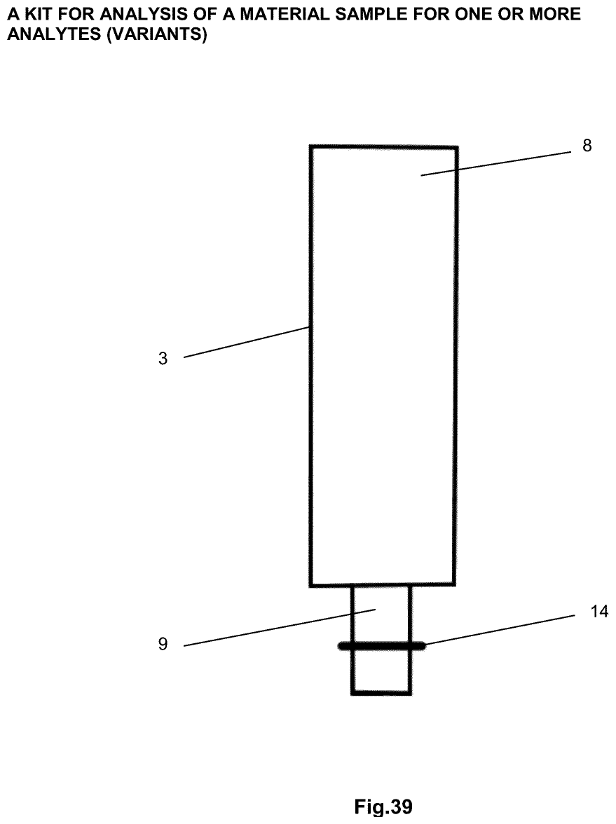

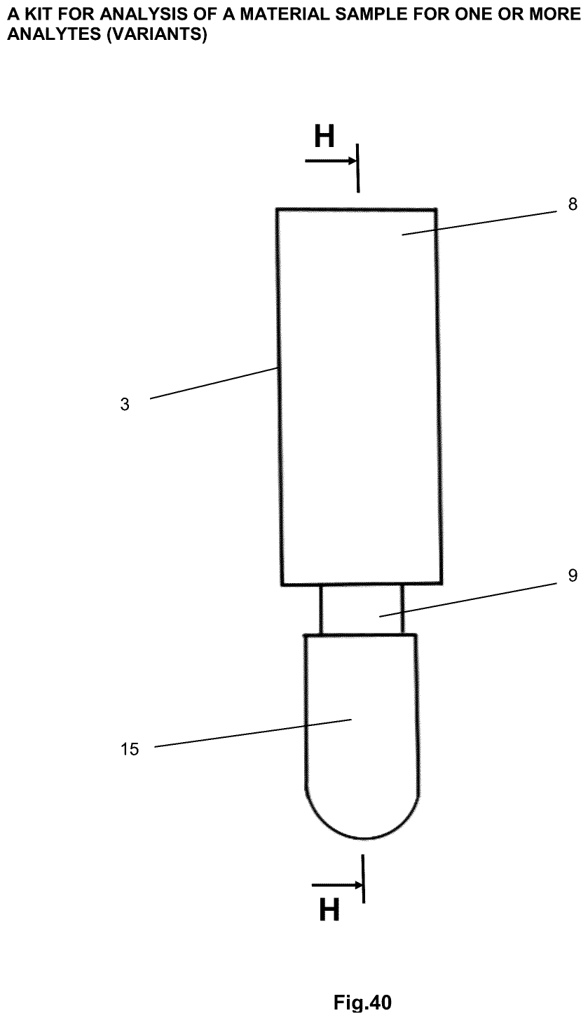

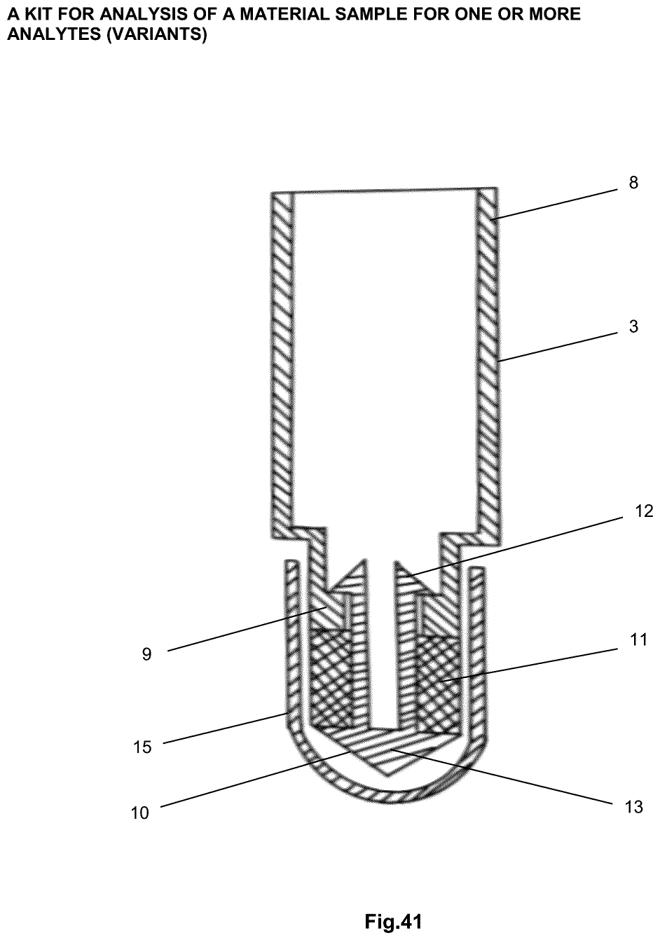

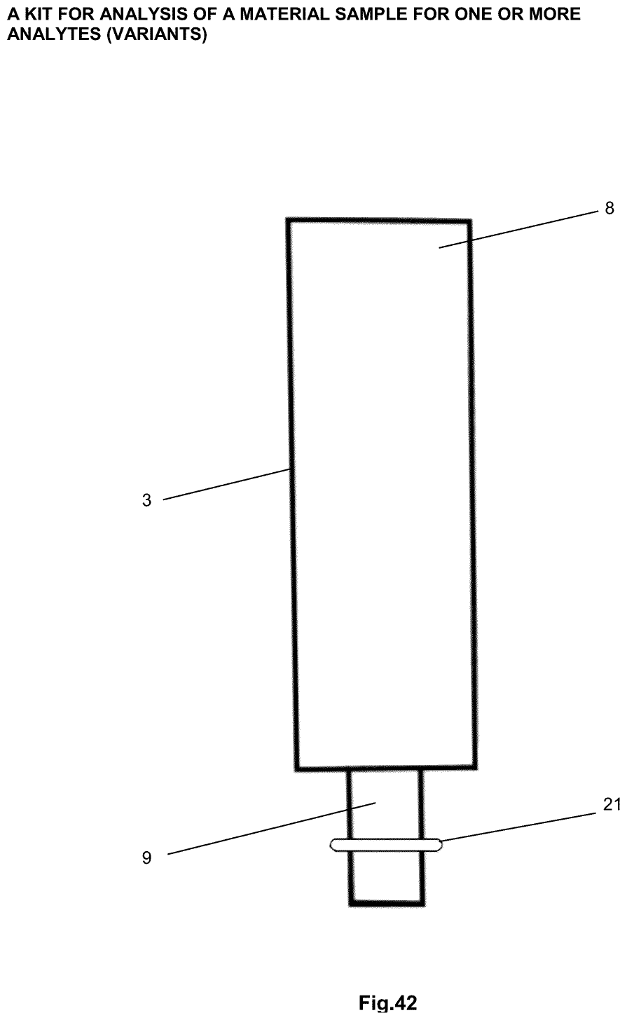

According to one of the embodiments, the test device (1) can comprise the sealing ring (14) (see FIGS. 39, 40, and 41) arranged on the outer portion of the second end (9) of the housing and can comprise the protective cap (15) mounted on the second end (9) of the housing so that its inner surface is in contact with the sealing ring (14). The protective cap (15) protects the element for receiving the material sample (11) from contact with other objects, thus maintaining the sterility of the element for receiving the material sample (11). In order to hold the sealing ring (14), according to one of the embodiments, the outer part of the second end (9) of the housing can comprise two retaining collars (24) (see FIG. 12) configured to hold the sealing ring (14) at the second end (9) of the housing.

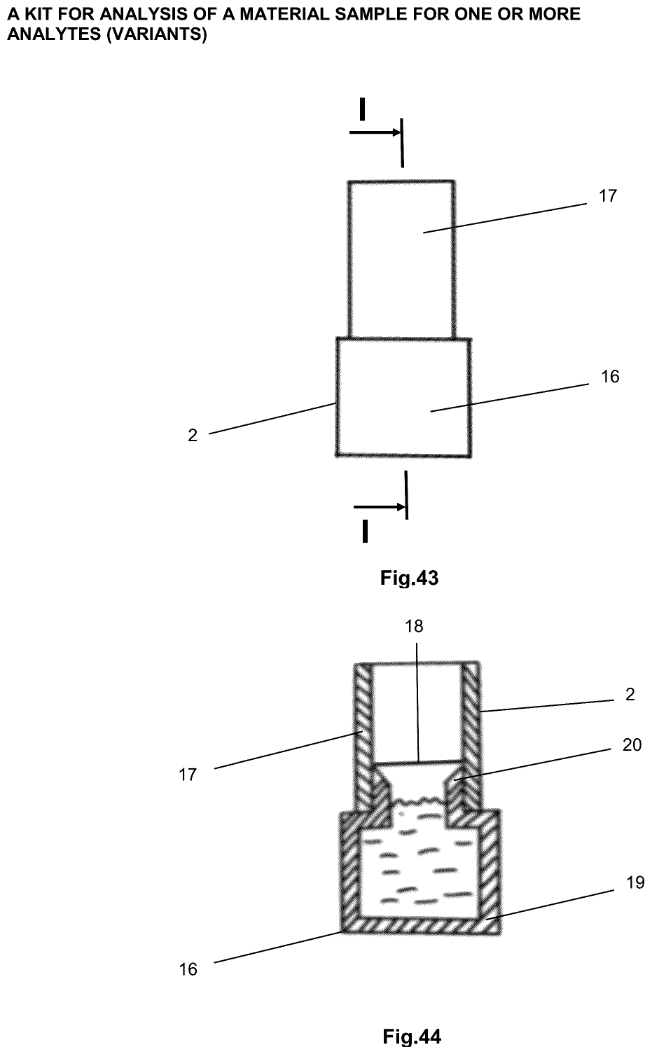

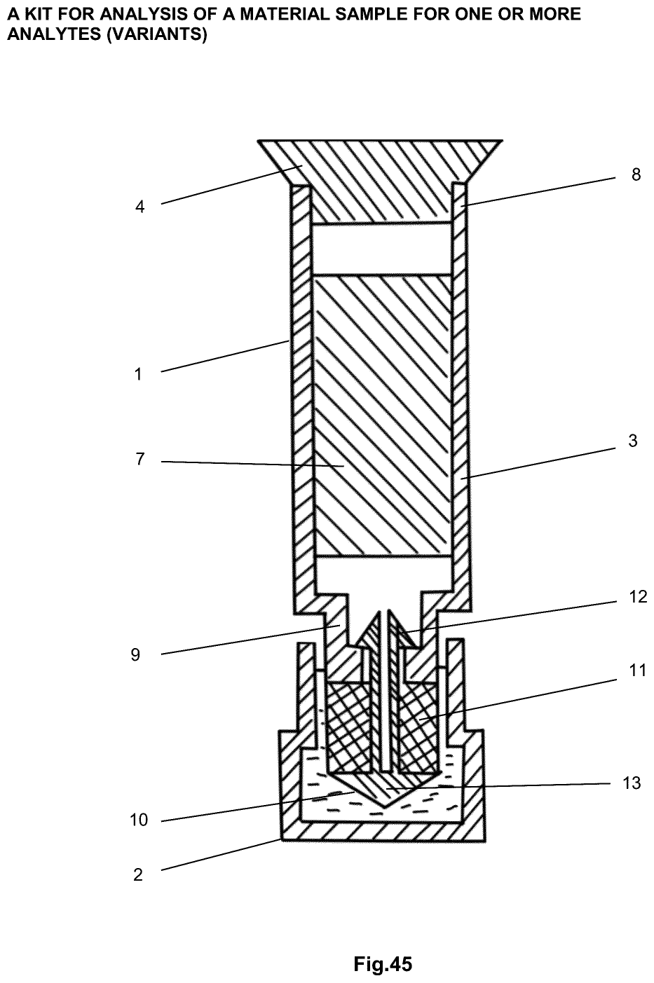

According to one of the embodiments, the container (2) can comprise the vessel containing the buffer fluid (16), the receiving tip (17), and the impermeable membrane (18) (see FIGS. 43, 44, and 45). The vessel containing the buffer fluid (16) can comprise the housing (19) of the vessel containing the buffer fluid and the neck (20) of the vessel containing the buffer fluid. The impermeable membrane (18) is configured in a shape of the disk made of impermeable material (e.g. foil) and mounted on the neck (20) of the vessel containing the buffer fluid so that it closes the orifice in the neck (20) of the vessel containing the buffer fluid and prevents the buffer fluid from being spilled out during transportation and storage. The receiving tip (17) is configured to receive the end of the test device (1) with the attached assembly for receiving the material sample (5) and holding the test device (1) in the certain position that can be considered close to the vertical position.

According to one of the embodiments, the geometric sizes of the second end (9) of the housing and the receiving tip (17) are adjusted such that when the second end (9) of the housing with the attached assembly for receiving the material sample is introduced into the receiving tip (17), the sealing ring (14) arranged on the outer portion of the second end of the housing (9) comes into close constant contact with the inner surface of the receiving tip (17), and a friction force, that fixes the test device (1) in the container (2), occurs. In this case, when the test device (1) is introduced into the container (2) and then the test device (1) is pushed along the receiving tip (17), the buffer fluid is displaced from the vessel containing the buffer fluid (16) to the element for receiving the material sample (11). After that the buffer fluid passes through the rod (10) and enters the housing (3) reaching the test strip holder (7). A similar pattern may occur in the presence of the sealing collar (21).

According to one of the embodiments, the outer portion of the second end (9) of the housing can comprise the sealing collar (21) (see FIG. 31). In this embodiment, the mutual geometric sizes of the second end (9) of the housing and the receiving tip (17), as well as the geometric sizes of the sealing collar (21) are adjusted such that when the second end (9) of the housing with the attached assembly for receiving the material sample (5) is introduced into the receiving tip (17), the radial surface of the sealing collar (21) comes into close constant contact with the inner surface of the receiving tip (17), and a friction force, that fixes the test device (1) into the container (2), occurs.

It is apparent and clear to one skilled in the art that the test device (1) and the container (2) can be used as analogous devices, i.e., when using the claimed disclosure, the portion of the test device (1) is arranged inside the container (2) and is held by the container (2) in a vertical position, with no fixation of the test device (1) inside the container (2), and the buffer fluid itself passes through the assembly for receiving the material sample (5) and enters the housing (3) reaching the end of the test strip holder (7).

The following are possible examples of the use of the claimed disclosure.

### Example 1

In this example, the kit according to the claimed disclosure is used as follows. Remove the test device (1) and the container (2), which may be located in a single primary package or in two primary packages, from the primary package. Remove the protective cap (15) mounted on the second end (9) of the housing from the test device (1) so that its inner surface is in contact with the sealing ring (14). Apply the volume of the sample, such as blood, that has been already collected and prepared for the analysis, on the element for receiving the material sample (11).

After receiving the material sample on the element for receiving the material sample (11), introduce the test device (1) into the receiving tip (17) of the container (2) so that the second end of the rod (13) reaches the impermeable membrane (18), pierces the impermeable membrane (18) and leans against the bottom of the vessel containing the buffer fluid (16). The element for receiving the material sample (11) is located in the buffer fluid. Either the sealing ring (14) or the sealing collar (21) protects the buffer fluid from being spilt out of the container (2). The buffer fluid passes through the element for receiving the material sample (11) and the rod (10) into the orifice in the second end (9) of the housing, and then passes into the housing (3), where it enters the end of the test strip holder (7), which has two test strips (6). The first of the test strips (6) is configured for analysis of the material sample for the analyte, such as antibodies to coronavirus, and the second of the test strips (6) is configured for analysis of the material sample for the analyte, such as antibodies to influenza virus. In this case, antibodies to coronavirus and antibodies to influenza virus are disease markers. After a few minutes, look at the test strips (6) through the transparent housing (3) and observe the display of the results of the analysis of the material sample as colored lines on the test strips (6). According to the position of the colored lines on the test strips, detect the presence or absence of the antibodies to the coronavirus and influenza virus in the material sample, and make conclusion on the presence or absence of the disease.

### Example 2

In Example 2, the kit according to the claimed disclosure is used similarly to the application of the kit according to the disclosure claimed in Example 1. The difference between Example 2 and Example 1 is as follows:
the test strip holder (7) comprises two test strips (6), first of the test strips (6) is configured for the test of the material sample for the analyte, such as coronavirus antigen, and the second of the test strips (6) is configured for the test of the material sample for the analyte, such as influenza virus antigen, wherein, in this case, coronavirus antigen and influenza virus antigen are disease markers;
reception of the material sample by the element for receiving a material sample (11) is performed by direct collection of the material, such as a swab from the nasal cavity, which is accomplished by introducing the element for receiving the material sample (11) into the nasal cavity and sliding the surface of the element for receiving a material sample (11) along the nasal mucosa, for example, by rotating the test device (1) several times;
the user detects the presence or absence of the coronavirus antigen and influenza virus antigen in the sample according to the position of the colored lines on the test strips (6) and makes a conclusion on the presence or absence of the disease.

It will be apparent to one skilled in the art that the claimed disclosure may be used similarly to the examples described above for the analysis of any other possible material samples for any other analytes.

The disclosure enables achieving the following technical result:
configuration of the test strip holder and multiple test strips enables rapid and easy detection of the multiple analytes in the material sample;
due to the configuration of the element for receiving the material sample (11) in a shape of the hollow cylinder with the first end (33) of the hollow cylinder and the second end (34) of the hollow cylinder, where the first end (33) of the hollow cylinder is configured to be open, the second end (34) of the hollow cylinder is configured to be closed, the element for receiving the material sample (11) closes the second end (13) of the rod that has the cone, which prevents irritation or trauma of the mucous membranes when collecting the material;
since the test device and the container are arranged separately and not interconnected when transporting, the possibilities of the accidental piercing of the impermeable membrane in the container, further spillage of the buffer fluid from the container and unsuitability of the device for further utilization are eliminated.

The described examples of the embodiments only illustrate the disclosure, but do not limit it.

1. A kit for analysis of a material sample for one or more analytes, the kit comprising: a test device for receiving the material sample and for displaying the result of the analysis of the material sample, and a container for storing a buffer fluid required for the analysis of the material sample; the test device comprises a housing configured in a shape of a tube made of the transparent material, wherein the housing comprises a first end of the housing and a second end of the housing, a locking tip connected to the first end of the housing, an assembly for receiving the material sample connected to the second end of the housing, at least one test strip for analysis of the material sample for the analyte and for display of the result of the analysis; a test strip holder for holding at least one test strip fixed inside that is located inside the housing; the assembly for receiving the material sample comprises a rod and an element for receiving the material sample, wherein the first end of the rod is connected to the second end of the housing in such a way that a portion of the rod is arranged inside the orifice of the second end of the housing; the element for receiving the material sample is mounted on the rod, characterized in that the test strip holder is configured
either in a preferably cylindrical shape, wherein the surface of the test strip holder comprises at least one recess for holding the test strip fixed,
or in a preferably prism shape with a lateral surface formed by three or more lateral faces, each of which is a rectangle or parallelogram, and the surface of the lateral faces comprises one or more recesses for holding the test strips fixed,
or to comprise a central longitudinal element, three or more longitudinal protrusions and at least one radial ring element, wherein a central longitudinal element is configured in a preferably prism shape with lateral edges and a lateral surface formed by three or more lateral faces, each of which is a rectangle or a parallelogram, wherein the longitudinal protrusions are configured in such a way that each of them in cross-section has a shape of a truncated sector of a circle, and each longitudinal protrusion is connected to the lateral edge of the central longitudinal element, wherein the radial ring element is connected to the longitudinal protrusions and is configured in such a way that slots are formed between an inner surface of the radial ring element and the surface of the lateral faces.

2. The kit according to claim 1, characterized in that the test device comprises one, two, three, four, five or six test strips.

3. The kit according to claim 1, characterized in that the test strip holder is connected to the locking tip.

4. The kit according to claim 1, characterized in that the test strip holder is connected to the housing.

5. The kit according to claim 1, characterized in that the housing is configured in a shape of the tube in such a way that it has a preferably cylindrical shape.

6. The kit according to claim 1, characterized in that the housing is configured in a shape of the tube in such a way that it preferably has the lateral surface formed by three or more lateral faces, each of which is a rectangle or parallelogram.

7. The kit according to claim 6, characterized in that the lateral surface of the housing is formed by three, four, five or six lateral faces.

8. The kit according to claim 1, characterized in that the test strip holder is configured in a preferably prism shape with three, four, five or six lateral faces.

9. The kit according to claim 8, characterized in that at least one recess for holding the test strip fixed are arranged on one, two, three, four, five or six lateral faces.

10. The kit according to claim 1, characterized in that the test strip holder comprises the central longitudinal element, three longitudinal protrusions and one radial ring element, wherein the central longitudinal element is configured in a preferably prism shape with three lateral edges and the lateral surface formed by three lateral faces, wherein the radial ring element is configured to form three slots.

11. The kit according to claim 1, characterized in that the test strip holder comprises the central longitudinal element, four longitudinal protrusions and one radial ring element, wherein the central longitudinal element is configured in a preferably prism shape with four lateral edges and the lateral surface formed by four lateral faces, wherein the radial ring element is configured to form four slots.

12. The kit according to claim 1, characterized in that the test strip holder is configured in a preferably cylindrical shape, and further comprises at least one radial ring element, wherein at least one recess on the surface of the test strip holder are configured in such a way that at least one longitudinal plane is formed on the surface of the test strip holder, wherein the radial ring element is configured in such a way that slots are formed between the inner surface of the radial ring element and the surface of the longitudinal planes.

13. The kit according to claim 1, characterized in that the test device further comprises a sealing ring arranged on an outer portion of the second end of the housing, and further comprises a protective cap mounted on the second end of the housing in such a way that the protective cap is in contact with the sealing ring and prevents the element for receiving the material sample from contact with other objects.

14. The kit according to claim 1, characterized in that the element for receiving the material sample is made of porous material or fibrous material.

15. The kit according to claim 1, characterized in that the element for receiving the material sample is configured in a cylindrical shape with an axial channel.

16. The kit according to claim 1, characterized in that the element for receiving the material sample is configured in a shape of the hollow cylinder comprising a first end of the hollow cylinder and a second end of the hollow cylinder, wherein the first end of the hollow cylinder is configured to be open, the second end of the hollow cylinder is configured to be closed.

17. The kit according to claim 1, characterized in that the first end of the rod is configured in a hook-like shape in such a way that it comprises a stop element that can be bent back when being pressed and prevents the first end of the rod from getting out from the second end of the housing, when a portion of the rod is inside the orifice in the second end of the housing.

18. The kit according to claim 1, characterized in that the container comprises a vessel containing the buffer fluid, a receiving tip for receiving the end of the test device with the attached assembly for receiving the material sample and for holding the test device in a certain position, and an impermeable membrane; the vessel containing the buffer fluid comprises a housing of the vessel containing the buffer fluid and a neck of the vessel containing the buffer fluid; the impermeable membrane is configured in a shape of the disk made of impermeable material and mounted on the neck in such a way that the impermeable membrane closes the orifice in the neck and prevents the buffer fluid from being split out during transportation and storage; the receiving tip is configured in a shape of the tube to be mounted on the housing of the vessel containing the buffer fluid or on the outer portion of the neck of the vessel containing the buffer fluid.

19. The kit according to claim 1, characterized in that the outer portion of the second end of the housing comprises a sealing collar.

20. The kit according to claim 13, characterized in that the outer portion of the second end of the housing comprises two retaining collars for holding the sealing ring arranged on the outer portion of the second end of the housing.

21. The kit according to claim 1, characterized in that the analyte or analytes are preferably selected from the group of substances consisting of antigens, antibodies, hormones, antibiotics, addictive substances, vitamins, disease markers, markers of allergic reactions, food quality markers, and the like.

22. The kit according to claim 21, characterized in that the antigens and antibodies are antigens of viruses and antibodies to viruses, such as influenza viruses, coronaviruses, adenoviruses, human respiratory syncytial virus, HIV, hepatitis viruses, Epstein-Barr virus, Zika virus, dengue fever viruses, chikungunya fever virus, rubella virus, human cytomegalovirus, herpes viruses, and the like.

23. The kit according to claim 21, characterized in that the hormones are preferably selected from the group of substances consisting of chorionic gonadotropin, luteinizing hormone, follicle-stimulating hormone, protein-1 that binds insulin-like growth factor, thyroid-stimulating hormone, thyroxine, triiodothyronine, and the like.

24. The kit according to claim 21, characterized in that the addictive substances are preferably selected from the group of substances consisting of cannabinoids, synthetic cannabinoids, morphine, ecstasy, barbiturates, benzodiazepines, cocaine, amphetamine, methamphetamine, mephedrone, tramadol, oxycodone, pregabalin, tricyclic antidepressants, zopiclone, and the like.

25. The kit according to claim 21, characterized in that the diseases are preferably respiratory diseases, infectious diseases, sexually transmitted diseases, hormonal diseases, transmissible diseases, infections of the gastrointestinal tract, cardiovascular diseases, diseases of any organs, kidney diseases, liver diseases, and the like.

26. The kit according to claim 21, characterized in that the allergic reactions are preferably reactions to such factors as drugs, food, milk protein, gluten, egg white, seafood, peanuts, animals, cat hair, dog hair, pollen, ragweed pollen, fungus, mold, and the like.

27. A kit for analysis of a material sample for one or more analytes, the kit comprising: a test device for receiving the material sample and for displaying the result of the analysis of the material sample, and a container for storing a buffer fluid required for the analysis of the material sample; the test device comprises a housing configured in a shape of a tube made of the transparent material, the housing comprises a first end of the housing and a second end of the housing, a locking tip connected to the first end of the housing, an assembly for receiving the material sample connected to the second end of the housing, at least one test strip for analysis of the material sample for the analyte and for display of the result of the analysis; a test strip holder for holding at least one test strip fixed inside that is located inside the housing; the assembly for receiving the material sample comprises a rod and an element for receiving the material sample, wherein the first end of the rod is connected to the second end of the housing in such a way that a portion of the rod is arranged inside the orifice of the second end of the housing; the element for receiving the material sample is mounted on the rod, characterized in that the element for receiving the material sample is configured in a shape of a hollow cylinder comprising a first end of the hollow cylinder and a second end of the hollow cylinder, wherein the first end of the hollow cylinder is configured to be open, and the second end of the hollow cylinder is configured to be closed.

28. The kit according to claim 27, characterized in that the test device comprises one, two, three, four, five or six test strips.

29. The kit according to claim 27, characterized in that the element for receiving the material sample is made of porous material or fibrous material.

30. The kit according to claim 27, characterized in that the test strip holder is connected to the locking tip.

31. The kit according to claim 27, characterized in that the test strip holder is connected to the housing.

32. The kit according to claim 27, characterized in that the housing is configured in a shape of the tube in such a way that it has a preferably cylindrical shape.

33. The kit according to claim 27, characterized in that the housing is configured in a shape of the tube in such a way that it has a preferably lateral surface formed by three or more lateral faces, each of which is a rectangle or parallelogram.

34. The kit according to claim 33, characterized in that the lateral surface of the housing is formed by three, four, five or six lateral faces.

35. The kit according to claim 27, characterized in that the test strip holder is configured in a preferably cylindrical shape, wherein the surface of the test strip holder comprises at least one recess for holding the test strip fixed.

36. The kit according to claim 35, characterized in that the test strip holder further comprises at least one radial ring element, wherein at least one recess on the surface of the test strip holder are configured in such a way that at least one longitudinal plane is formed on the surface of the test strip holder, wherein the radial ring element is configured in such a way that slots are formed between the inner surface of the radial ring element and the surface of the longitudinal planes.

37. The kit according to claim 27, characterized in that the test strip holder is configured in a preferably prism shape with the lateral surface formed by three or more lateral faces, each of which is a rectangle or parallelogram, and the surface of the lateral faces comprises at least one recess for holding the test strips fixed.

38. The kit according to claim 37, characterized in that the test strip holder is configured in a preferably prism shape with three, four, five or six lateral faces.

39. The kit according to claim 37, characterized in that at least one recess for holding the test strip fixed are arranged on one, two, three, four, five or six lateral faces.

40. The kit according to claim 27, characterized in that the test strip holder comprises a central longitudinal element, three or more longitudinal protrusions and at least one radial ring element, wherein the central longitudinal element is configured in a preferably prism shape with the lateral edges and the lateral surface formed by three or more lateral faces, each of which is a rectangle or a parallelogram, wherein the longitudinal protrusions are configured in such a way that each of them in cross-section has a shape of a truncated sector of a circle, and each longitudinal protrusion is connected to the lateral edge of the central longitudinal element, wherein the radial ring element is connected to the longitudinal protrusions and is configured in such a way that slots are formed between an inner surface of the radial ring element and the surface of the lateral faces.

41. The kit according to claim 40, characterized in that the test strip holder comprises the central longitudinal element, three longitudinal protrusions and one radial ring element, wherein the central longitudinal element is configured in a preferably prism shape with three lateral edges and the lateral surface formed by three lateral faces, wherein the radial ring element is configured to form three slots.

42. The kit according to claim 40, characterized in that the test strip holder comprises the central longitudinal element, four longitudinal protrusions and one radial ring element, wherein the central longitudinal element is configured in the preferably prism shape with four lateral edges and the lateral surface formed by four lateral faces, wherein the radial ring element is configured to form four slots.

43. The kit according to claim 27, characterized in that the test device further comprises a sealing ring located on an outer portion of the second end of the housing, and further comprises a protective cap mounted on the second end of the housing in such a way that the protective cap is in contact with the sealing ring and prevents the element for receiving the material sample from contact with other objects.

44. The kit according to claim 27, characterized in that the first end of the rod is configured in a hook-like shape in such a way that it comprises a stop element that can be bent back when being pressed and prevents the first end of the rod from getting out from the second end of the housing, when a portion of the rod is inside the orifice in the second end of the housing.

45. The kit according to claim 27, characterized in that the container comprises a vessel containing the buffer fluid, a receiving tip for receiving the end of the test device with the attached assembly for receiving the material sample and for holding the test device in a certain position, and an impermeable membrane; the vessel containing the buffer fluid comprises a housing of the vessel containing the buffer fluid and a neck of the vessel containing the buffer fluid; the impermeable membrane is configured in a shape of the disk made of impermeable material and mounted on the neck in such a way that the impermeable membrane closes the orifice in the neck and prevents the buffer fluid from being split out during transportation and storage; the receiving tip is configured in a shape of the tube to be mounted on the housing of the vessel containing the buffer fluid or on the outer portion of the neck of the vessel containing the buffer fluid.

46. The kit according to claim 27, characterized in that the outer portion of the second end of the housing comprises a sealing collar.

47. The kit according to claim 43, characterized in that the outer portion of the second end of the housing comprises two retaining collars for holding the sealing ring arranged on the outer portion of the second end of the housing.

48. The kit according to claim 27, characterized in that the analyte or analytes are preferably selected from the group of substances consisting of antigens, antibodies, hormones, antibiotics, addictive substances, vitamins, disease markers, markers of allergic reactions, food quality markers, and the like.

49. The kit according to claim 48, characterized in that the antigens and antibodies are antigens of viruses and antibodies to viruses, such as influenza viruses, coronaviruses, adenoviruses, human respiratory syncytial virus, HIV, hepatitis viruses, Epstein-Barr virus, Zika virus, dengue fever viruses, chikungunya fever virus, rubella virus, human cytomegalovirus, herpes viruses, and the like.

50. The kit according to claim 48, characterized in that the hormones are preferably selected from the group of substances consisting of chorionic gonadotropin, luteinizing hormone, follicle-stimulating hormone, protein-1 that binds insulin-like growth factor, thyroid-stimulating hormone, thyroxine, triiodothyronine, and the like.

51. The kit according to claim 48, characterized in that the addictive substances are preferably selected from the group of substances consisting of cannabinoids, synthetic cannabinoids, morphine, ecstasy, barbiturates, benzodiazepines, cocaine, amphetamine, methamphetamine, mephedrone, tramadol, oxycodone, pregabalin, tricyclic antidepressants, zopiclone, and the like.

52. The kit according to claim 48, characterized in that the diseases are preferably respiratory diseases, infectious diseases, sexually transmitted diseases, hormonal diseases, transmissible diseases, infections of the gastrointestinal tract, cardiovascular diseases, diseases of any organs, kidney diseases, liver diseases, and the like.

53. The kit according to claim 48, characterized in that the allergic reactions are preferably reactions to such factors as drugs, food, milk protein, gluten, egg white, seafood, peanuts, animals, cat hair, dog hair, pollen, ragweed pollen, fungus, mold, and the like.
